(19) United States
(12) Patent Application Publication
(10) Pub. No.: US 2025/0030020 A1
(43) Pub. Date: Jan. 23, 2025

(54) DIAGNOSIS SYSTEMS AND METHODS FOR FUEL CELL ASSEMBLIES

(71) Applicant: General Electric Company, Schenectady, NY (US)

(72) Inventors: Honggang Wang, Clifton Park, NY (US); Radislav A. Potyrailo, Niskayuna, NY (US); Michael Anthony Benjamin, Cincinnati, OH (US); Xiangdong Kong, Shanghai (CN)

(21) Appl. No.: 18/731,811

(22) Filed: Jun. 3, 2024

(30) Foreign Application Priority Data
Jul. 18, 2023 (CN) 202310879492.5

(51) Int. Cl. H01M 8/04664; B64D 27/10; B64D 27/33; B64D 27/355; F02C 7/22; G01M 3/26; H01M 8/0438; H01M 8/0444; H01M 8/2475

(52) U.S. Cl. CPC H01M 8/04671; B64D 27/10; B64D 27/33; B64D 27/355; F02C 7/22; G01M 3/26; H01M 8/04402; H01M 8/0441; H01M 8/0444; H01M 8/04462; H01M 8/0447; H01M 8/2475; F05D 2260/80; H01M 2250/20

(57) ABSTRACT

A fuel cell assembly is provided, including a fuel cell stack having a fuel cell, the fuel cell having a cathode and an anode; and a multi-gas sensor configured to sense gas composition data of a flow of output products from the cathode, gas composition data of a flow of output products from the anode, gas composition data of a fluid surrounding the fuel cell, or a combination thereof to determine fuel cell leakage diagnostic information.

### PRIORITY INFORMATION

This application claims the benefit of priority to CN Patent Application 202310879492.5 filed in the Patent Office of China National Intellectual Property Administration on Jul. 18, 2023.

### FIELD

The present disclosure relates to a system and method for operating a fuel cell assembly, such as a fuel cell assembly integrated into a gas turbine engine.

### BACKGROUND

Fuel cell stacks include a grouping of individual fuel cells, each including an anode, a cathode, and an electrolyte in the form of a matrix disposed therebetween. Also included in the fuel cell stacks are passageways to and from the anode and the cathode to permit the in-flow of fuel and oxidant to the anode and cathode respectively, and the out-flow of any excess fuel and oxidant, and of byproducts such as water.

Operation of the fuel cell stack to produce electricity includes introducing a fuel such as hydrogen into the anode passageway. Meanwhile, an oxidant such as air is introduced into the cathode passageway. Oxidation of hydrogen occurs at the anode to produce hydrogen ions and free electrons. These electrons flow through an external load, thereby producing electricity, while the hydrogen ions migrate through a matrix to the cathode. At the cathode, the hydrogen ions and free electrons react with the oxygen to form water.

The passageways directing fuel to the anode and oxidant to the cathode are separate and distinct. Since mixing of the fuel and oxidant is undesirable, it may be important to keep these substances separate. As a result, it may be important to detect leakage which could allow direct contact between these substances, either overboard leakage or crossover leakage. Overboard leakage is leakage from the passageways out of the cell which occurs while the fuel and oxidant are being directed to the anode and cathode. Crossover leakage is leakage between the anode and cathode through the matrix within the cells which occurs when a hole develops in the matrix. Heating and cooling, particularly of high temperature fuel cell assemblies, generate load stresses which can cause crossover and overboard leaks. Crossover leaks cross-contaminate the reactants reducing efficiency or damaging the fuel cells. Overboard leaks also reduce efficiency due to the loss of reactants. Leaks can occur at any fluid interface in the fuel cell assembly such as at the fuel cells, ports and end plates.

The inventors of the present disclosure have therefore found that a fuel cell leak diagnosis system and method would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a perspective view of an integrated fuel cell and combustor assembly in accordance with the present disclosure.

FIG. 3 is a schematic, axial view of the exemplary integrated fuel cell and combustor assembly of FIG. 2.

FIG. 4 is a schematic view of a fuel cell of a fuel cell assembly in accordance with an exemplary aspect of the present disclosure as may be incorporated into the exemplary integrated fuel cell and combustor assembly of FIG. 2.

FIG. 5 is a schematic diagram of a gas turbine engine including an integrated fuel cell and combustor assembly in accordance with an exemplary aspect of the present disclosure.

FIG. 6 is a schematic view of a fuel cell assembly in accordance with an exemplary embodiment of the present disclosure.

FIG. 7 is a schematic view of a fuel cell assembly in accordance with another exemplary embodiment of the present disclosure.

FIG. 8 is a schematic view of a fuel cell assembly in accordance with yet another exemplary embodiment of the present disclosure.

FIG. 9 is a schematic view of a fuel cell assembly in accordance with still another exemplary embodiment of the present disclosure.

FIG. 10 is a schematic view of a fuel cell assembly in accordance with yet another exemplary embodiment of the present disclosure.

FIG. 11 is a schematic view of a fuel cell assembly in accordance with still another exemplary embodiment of the present disclosure.

FIG. 12 is a schematic view of a fuel cell assembly in accordance with yet another exemplary embodiment of the present disclosure.

FIG. 13 is a schematic view of a fuel cell assembly in accordance with still another exemplary embodiment of the present disclosure.

FIG. 14 is a flow diagram of a method for determining fuel cell leakage diagnostic information in accordance with an exemplary aspect of the present disclosure.

FIG. 15 is a flow diagram of an exemplary aspect of the method of FIG. 13 for determining fuel cell leakage diagnostic information relating to overboard leakage.

FIG. 16 is a flow diagram of an exemplary aspect of the method of FIG. 13 for determining fuel cell leakage diagnostic information relating to cross-leakage.

FIG. 17 illustrates one embodiment of a multi-gas sensing system in accordance with one embodiment.

FIG. 18 illustrates a sensing circuit of the multi-gas sensing system shown in FIG. 17.

FIG. 19 illustrates a system layout of a multi-gas sensing system in accordance with one embodiment.

FIG. 20 illustrates a flowchart of one embodiment of a method for sensing multiple different gas analytes using the multi-gas sensing system in accordance with one embodiment.

FIG. 21 illustrates graphical illustrations of electrical responses of individual sensing elements of a multi-gas sensing system in accordance with one embodiment.

FIG. 22 illustrates graphical illustrations of electrical responses of analyzed electrical responses of the individual sensing elements of the multi-gas sensing system shown in FIG. 21.

FIG. 23 illustrates graphical illustrations of responses of a metal oxide sensing element to a gas of interest in accordance with one embodiment.

FIG. 24 illustrates graphical illustrations of quantitation of gas concentrations using dielectric excitation gas detection in accordance with one embodiment.

FIG. 25 illustrates effects of water vapor over a range of relative humidity on resistance and dielectric excitation responses.

FIG. 26 illustrates graphical illustrations of operation of a multi-gas monitor under dynamic wind conditions in accordance with one embodiment.

FIG. 27 is an illustration of responses of a sensing element to hydrogen and methane in accordance with one embodiment.

FIG. 28 illustrates graphical illustrations of quantitation of gas concentrations using dielectric excitation gas detection in accordance with one embodiment.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” or “at least one of A, B, or C” refers to only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees fahrenheit (such as less than 300 degrees fahrenheit, such as less than 250 degrees fahrenheit, such as less than 200 degrees fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolytes. Each of these fuel cells may have specific benefits in the form of a preferred operating temperature range, power generation capability, efficiency, etc.

The present disclosure is generally related to a propulsion system having a propulsor; and a fuel cell assembly operable with the propulsor. The propulsor may be a gas turbine engine, such as a turbofan engine, and the fuel cell assembly may be integrated into the gas turbine engine.

The fuel cell assembly includes a fuel cell stack and a gas sensor. The fuel cell stack includes a fuel cell and the fuel cell includes a cathode and an anode. The gas sensor is configured to sense gas composition data of a flow of output products from the cathode, gas composition data of a flow of output products from the anode, gas composition data of a fluid surrounding the fuel cell, or a combination thereof to determine fuel cell leakage diagnostic information. As used herein, the term “gas composition data” refers to data indicating a percentage of one or more gaseous constituents in a fluid flow.

For example, the gas sensor may be configured to sense gas composition data of a flow of output products from the cathode, and in response to the gas composition data indicating an increase in CO₂, H₂O, cathode exhaust flowrate, or a combination thereof, determine an anode to cathode cross-leakage.

Further for example, the gas sensor may be configured to sense gas composition data of a flow of output products from the anode, and in response to the gas composition data indicating an increase in N₂, anode exhaust flowrate, or a combination thereof, determine a cathode to anode cross-leakage.

Further still for example, the gas sensor may be configured to sense gas composition data of a fluid surrounding the fuel cell, and in response to the gas composition data indicating a decrease in O₂ in the fluid, determine an overboard leakage from the anode if the O₂% is less than an O₂% at the cathode exhaust, or an overboard leakage from the cathode if the O₂% is greater than an O₂% at the cathode exhaust.

The gas sensor may be a multi-gas sensor for sensing the above data in line with the aforementioned flows.

Inclusion of a system in accordance with one or more of these exemplary aspects may provide for an improved fuel cell assembly as the fuel cell assembly may be configured to sense the data needed to accurately and quickly determine any leakage information to minimize damage and improve a life of the fuel cell assembly. Further, inclusion of a method of the present disclosure may provide timely feedback on the fuel cell status for any automatic/autonomous remedy control which may be important particularly for an aircraft use scenario. It may also provide service/repair data and root cause analysis to trace back which specific part in the fuel cell fails, which makes it possible for quality feedback to the fuel cell manufacturing line.

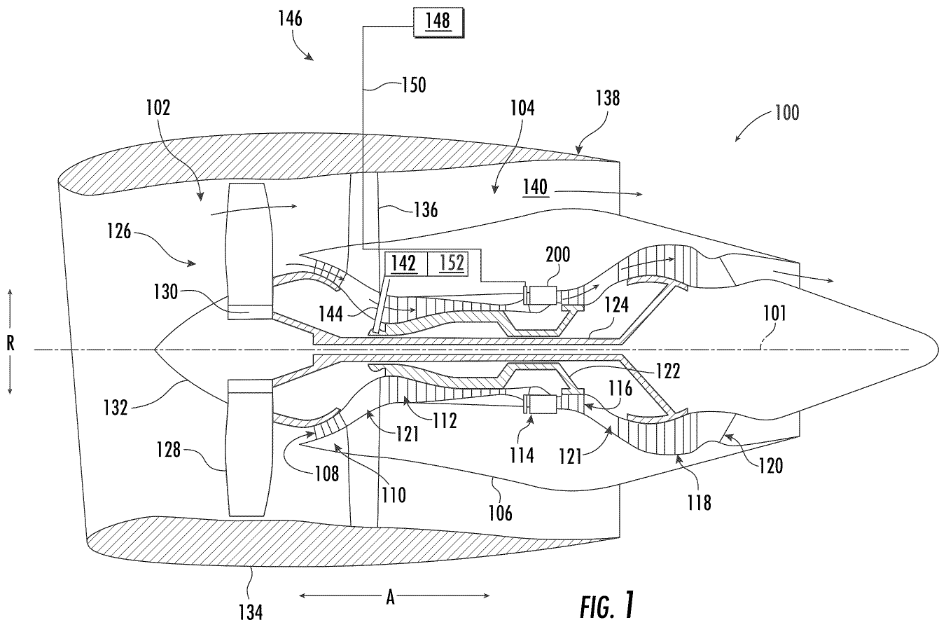

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable vehicle.

For the embodiment depicted, the engine is configured as a high bypass turbofan engine 100. As shown in FIG. 1, the turbofan engine 100 defines an axial direction A (extending parallel to a centerline axis 101 provided for reference), a radial direction R, and a circumferential direction (extending about the axial direction A; not depicted in FIG. 1). In general, the turbofan engine 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet exhaust nozzle section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the centerline axis 101 by the LP shaft 124. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

In such a manner, it will be appreciated that turbofan engine 100 generally includes a first stream (e.g., core air flowpath 121) and a second stream (e.g., bypass airflow passage 140) extending parallel to the first stream. In certain exemplary embodiments, the turbofan engine 100 may further define a third stream extending, e.g., from the LP compressor 110 to the bypass airflow passage 140 or to ambient. With such a configuration, the LP compressor 110 may generally include a first compressor stage configured as a ducted mid-fan and downstream compressor stages. An inlet to the third stream may be positioned between the first compressor stage and the downstream compressor stages.

Referring still to FIG. 1, the turbofan engine 100 additionally includes an accessory gearbox 142 and a fuel delivery system 146. The fuel delivery system 146 may be an aircraft fuel supply, such as an aircraft fuel supply for a propulsion system for an aircraft. For the embodiment shown, the accessory gearbox 142 is located within the cowling/outer casing 106 of the turbomachine 104. Additionally, it will be appreciated that for the embodiment depicted schematically in FIG. 1, the accessory gearbox 142 is mechanically coupled to, and rotatable with, one or more shafts or spools of the turbomachine 104. For example, in the exemplary embodiment depicted, the accessory gearbox 142 is mechanically coupled to, and rotatable with, the HP shaft 122 through a suitable geartrain 144. The accessory gearbox 142 may provide power to one or more suitable accessory systems of the turbofan engine 100 during at least certain operations, and may further provide power back to the turbofan engine 100 during other operations. For example, the accessory gearbox 142 is, for the embodiment depicted, coupled to a starter motor/generator 152. The starter motor/generator may be configured to extract power from the accessory gearbox 142 and turbofan engine 100 during certain operation to generate electrical power, and may provide power back to the accessory gearbox 142 and turbofan engine 100 (e.g., to the HP shaft 122) during other operations to add mechanical work back to the turbofan engine 100 (e.g., for starting the turbofan engine 100).

Moreover, the fuel delivery system 146 generally includes a fuel source 148, such as a fuel tank, and one or more fuel delivery lines 150. The one or more fuel delivery lines 150 provide a fuel flow through the fuel delivery system 146 to the combustion section 114 of the turbomachine 104 of the turbofan engine 100. As will be discussed in more detail below, the combustion section 114 includes an integrated fuel cell and combustor assembly 200. The one or more fuel delivery lines 150, for the embodiment depicted, provide a flow of fuel to the integrated fuel cell and combustor assembly 200.

It will be appreciated, however, that the exemplary turbofan engine 100 depicted in FIG. 1 is provided by way of example only. In other exemplary embodiments, any other suitable gas turbine engine may be utilized with aspects of the present disclosure. For example, in other embodiments, the turbofan engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine, in other embodiments, a gas turbine engine of the present disclosure may be a geared gas turbine engine (i.e., including a gearbox between the fan 126 and a shaft driving the fan, such as the LP shaft 124), may be a variable pitch gas turbine engine (i.e., including a fan 126 having a plurality of fan blades 128 rotatable about their respective pitch axes), etc. Moreover, although the exemplary turbofan engine 100 includes a ducted fan 126, in other exemplary aspects, the turbofan engine 100 may include an unducted fan 126 (or open rotor fan), without the nacelle 134. Further, although not depicted herein, in other embodiments the gas turbine engine may be any other suitable type of gas turbine engine, such as a nautical gas turbine engine.

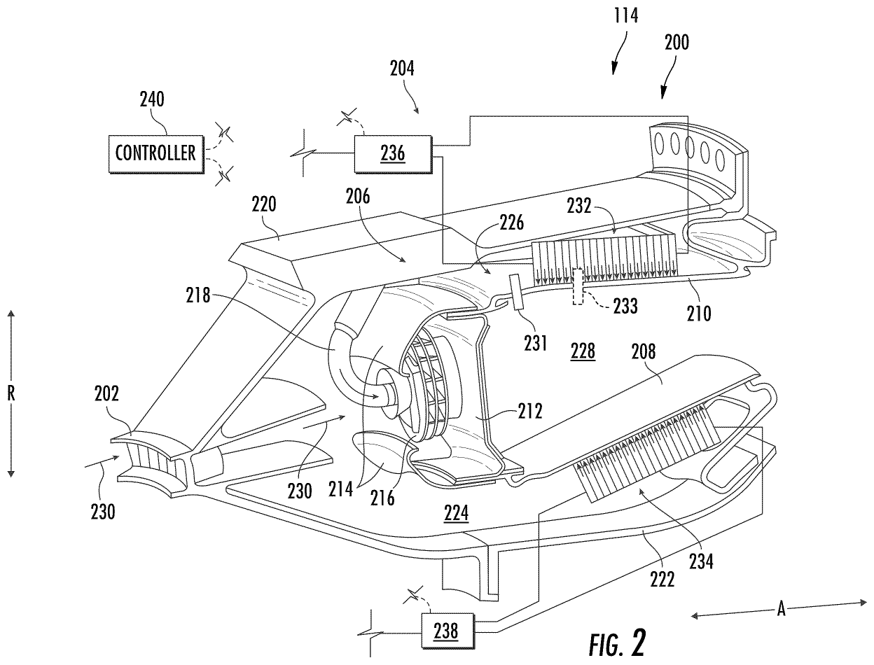

Referring now to FIG. 2, illustrated schematically is a portion of the combustion section 114 including a portion of the integrated fuel cell and combustor assembly 200 used in the gas turbine engine 100 of FIG. 1 (described as a turbofan engine 100 above with respect to FIG. 1), according to an embodiment of the present disclosure.

As will be appreciated, the combustion section 114 includes a compressor diffuser nozzle 202 and extends between an upstream end and a downstream end generally along the axial direction A. The combustion section 114 is fluidly coupled to the compressor section at the upstream end via the compressor diffuser nozzle 202 and to the turbine section at the downstream end.

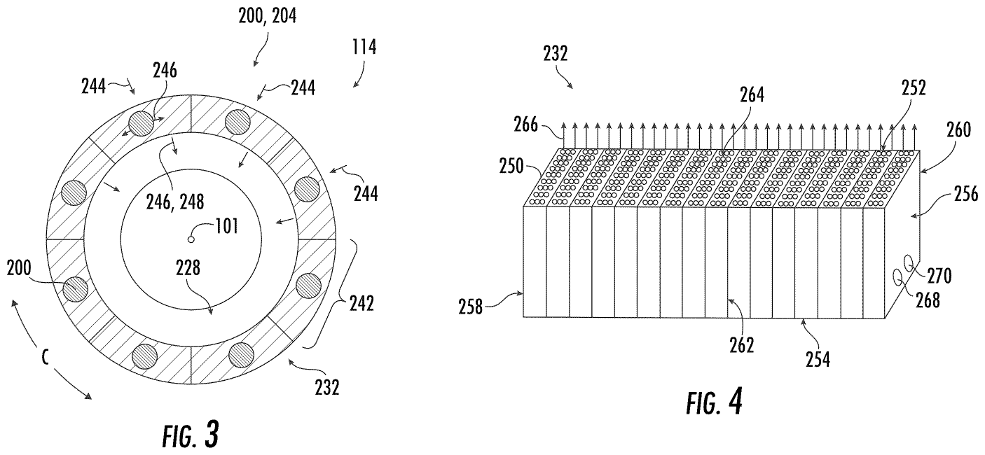

The integrated fuel cell and combustor assembly 200 generally includes a fuel cell assembly 204 (only partially depicted in FIG. 2; see also FIGS. 3 through 5) and a combustor 206. The combustor 206 includes an inner liner 208, an outer liner 210, a dome assembly 212, a cowl assembly 214, a swirler assembly 216, and a fuel flowline 218. The combustion section 114 generally includes an outer casing 220 outward of the combustor 206 along the radial direction R to enclose the combustor 206 and an inner casing 222 inward of the combustor 206 along the radial direction R. The inner casing 222 and inner liner 208 define an inner passageway 224 therebetween, and the outer casing 220 and outer liner 210 define an outer passageway 226 therebetween. The inner casing 222, the outer casing 220, and the dome assembly 212 together define at least in part a combustion chamber 228 of the combustor 206.

The dome assembly 212 is disposed proximate the upstream end of the combustion section 114 (i.e., closer to the upstream end than the downstream end) and includes an opening (not labeled) for receiving and holding the swirler assembly 216. The swirler assembly 216 also includes an opening for receiving and holding the fuel flowline 218. The fuel flowline 218 is further coupled to the fuel source 148 (see FIG. 1) disposed outside the outer casing 220 along the radial direction R and configured to receive the fuel from the fuel source 148. In such a manner, the fuel flowline 218 may be fluidly coupled to the one or more fuel delivery lines 150 described above with reference to FIG. 1.

The swirler assembly 216 can include a plurality of swirlers (not shown) configured to swirl the compressed fluid before injecting it into the combustion chamber 228 to generate combustion gas. The cowl assembly 214, in the embodiment depicted, is configured to hold the inner liner 208, the outer liner 210, the swirler assembly 216, and the dome assembly 212 together.

During operation, the compressor diffuser nozzle 202 is configured to direct a compressed fluid 230 from the compressor section to the combustor 206, where the compressed fluid 230 is configured to be mixed with fuel within the swirler assembly 216 and combusted within the combustion chamber 228 to generate combustion gasses. The combustion gasses are provided to the turbine section to drive one or more turbines of the turbine section (e.g., the high pressure turbine 116 and low pressure turbine 118).

During operation of the gas turbine engine 100 including the integrated fuel cell and combustor assembly 200, a flame within the combustion chamber 228 is maintained by a continuous flow of fuel and air. In order to provide for an ignition of the fuel and air, e.g., during a startup of the gas turbine engine 100, the integrated fuel cell and combustor assembly 200 further includes an ignitor 231. The ignitor 231 may provide a spark or initial flame to ignite a fuel and air mixture within the combustion chamber 228. In certain exemplary embodiments, the integrated fuel cell and combustor assembly 200 may additionally include a dedicated fuel cell ignitor 233 (depicted in phantom). In particular, for the embodiment of FIG. 2, the dedicated fuel cell ignitor 233 is positioned downstream of at least a portion of a fuel cell, and in particular of a fuel cell stack (described below). In such a manner, the dedicated fuel cell ignitor 233 may more effectively combust output products of the fuel cell.

As mentioned above and depicted schematically in FIG. 2, the integrated fuel cell and combustor assembly 200 further includes the fuel cell assembly 204. The exemplary fuel cell assembly 204 depicted includes a first fuel cell stack 232 and a second fuel cell stack 234. More specifically, the first fuel cell stack 232 is configured with the outer liner 210 and the second fuel cell stack 234 is configured with the inner liner 208. More specifically, still, the first fuel cell stack 232 is integrated with the outer liner 210 and the second fuel cell stack 234 is integrated with the inner liner 208. Operation of the fuel cell assembly 204, and more specifically of a fuel cell stack (e.g., first fuel cell stack 232 or second fuel cell stack 234) of the fuel cell assembly 204 will be described in more detail below.

For the embodiment depicted, the fuel cell assembly 204 is configured as a solid oxide fuel cell (“SOFC”) assembly, with the first fuel cell stack 232 configured as a first SOFC fuel cell stack and the second fuel cell stack 234 configured as a second SOFC fuel cell stack (each having a plurality of SOFC's). As will be appreciated, a SOFC is generally an electrochemical conversion device that produces electricity directly from oxidizing a fuel. In generally, fuel cell assemblies, and in particular fuel cells, are characterized by an electrolyte material utilized. The SOFC's of the present disclosure may generally include a solid oxide or ceramic electrolyte. This class of fuel cells generally exhibit high combined heat and power efficiency, long-term stability, fuel flexibility, and low emissions.

Moreover, the exemplary fuel cell assembly 204 further includes a first power converter 236 and a second power converter 238. The first fuel cell stack 232 is in electrical communication with the first power converter 236 by a first plurality of power supply cables (not labeled), and the second fuel cell stack 234 is in electrical communication with the second power converter 238 by a second plurality of power supply cables (not labeled).

The first power converter 236 controls the electrical current drawn from the corresponding first fuel cell stack 232 and may convert the electrical power from a direct current (“DC”) power to either DC power at another voltage level or alternating current (“AC”) power. Similarly, the second power converter 238 controls the electrical current drawn from the second fuel cell stack 234 and may convert the electrical power from a DC power to either DC power at another voltage level or AC power. The first power converter 236, the second power converter 238, or both may be electrically coupled to an electric bus (such as the electric bus 326 described below).

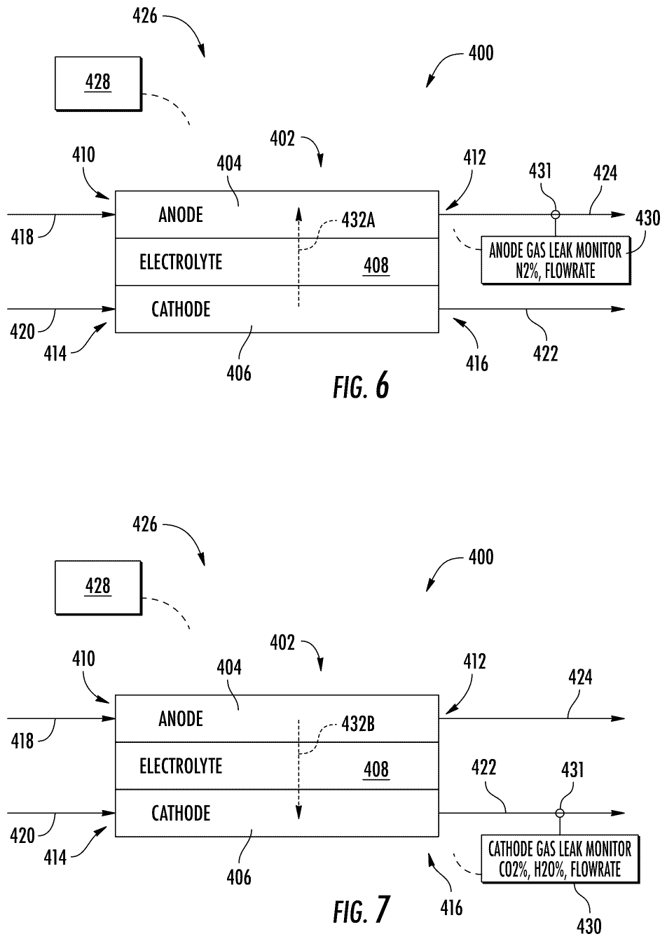

The integrated fuel cell and combustor assembly 200 further includes a fuel cell controller 240 that is in operable communication with both of the first power converter 236 and second power converter 238 to, e.g., send and receive communications and signals therebetween. For example, the fuel cell controller 240 may send current or power setpoint signals to the first power converter 236 and second power converter 238, and may receive, e.g., a voltage or current feedback signal from the first power converter 236 and second power converter 238. The fuel cell controller 240 may be configured in the same manner as the controller 240 described below with reference to FIG. 5.

It will be appreciated that in at least certain exemplary embodiments the first fuel cell stack 232, the second fuel cell stack 234, or both may extend substantially 360 degrees in a circumferential direction C of the gas turbine engine (i.e., a direction extending about the centerline axis 101 of the gas turbine engine 100). For example, referring now to FIG. 3, a simplified cross-sectional view of the integrated fuel cell and combustor assembly 200 is depicted according to an exemplary embodiment of the present disclosure. Although only the first fuel cell stack 232 is depicted in FIG. 3 for simplicity, the second fuel cell stack 234 may be configured in a similar manner.

As shown, the first fuel cell stack 232 extends around the combustion chamber 228 in the circumferential direction C, completely encircling the combustion chamber 228 around the centerline axis 101 in the embodiment shown. More specifically, the first fuel cell stack 232 includes a plurality of fuel cells 242 arranged along the circumferential direction C. The fuel cells 242 that are visible in FIG. 3 can be a single ring of fuel cells 242, with fuel cells 242 stacked together along the axial direction A (see FIG. 2) to form the first fuel cell stack 232. In another instance, multiple additional rings of fuel cells 242 can be placed on top of each other to form the first fuel cell stack 232 that is elongated along the centerline axis 101.

As will be explained in more detail, below, with reference to FIG. 5, the fuel cells 242 in the first fuel cell stack 232 are positioned to receive discharged air 244 from, e.g., the compressor section and fuel 246 from the fuel delivery system 146. The fuel cells 242 generate electrical current using this air 244 and at least some of this fuel 246, and radially direct partially oxidized fuel 246 and unused portion of air 248 into the combustion chamber 228 toward the centerline axis 101. The integrated fuel cell and combustor assembly 200 combusts the partially oxidized fuel 246 and air 248 in the combustion chamber 228 into combustion gasses that are directed downstream into the turbine section to drive or assist with driving the one or more turbines therein.

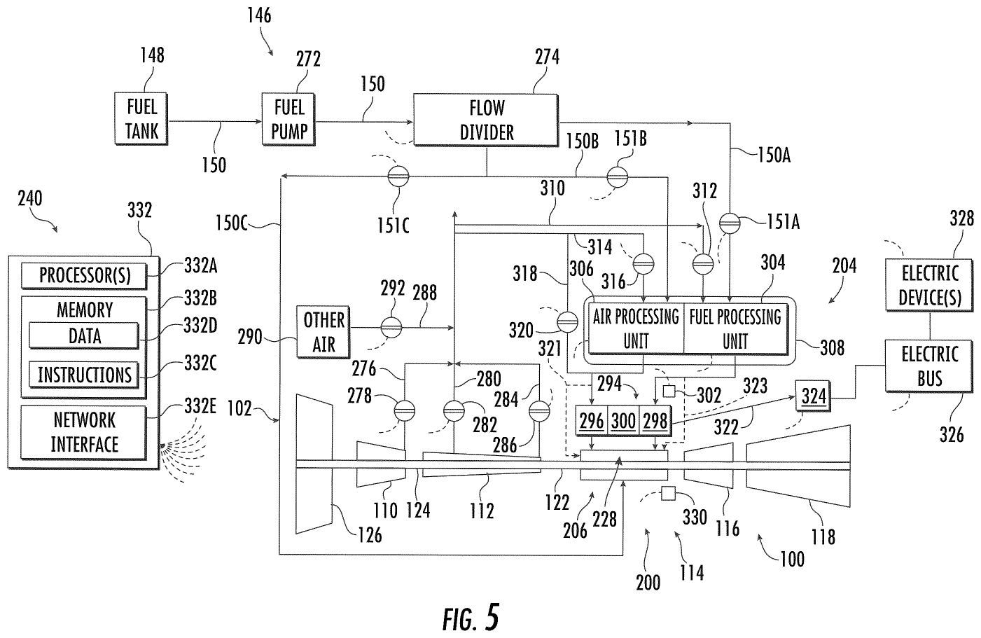

Moreover, referring now to FIG. 4, a schematic illustration is provided as a perspective view of the first fuel cell stack 232 of the integrated fuel cell and combustor assembly 200 of FIG. 2. The second fuel cell stack 234 may be formed in a similar manner.

The first fuel cell stack 232 depicted includes a housing 250 having a combustion outlet side 252 and a side 254 that is opposite to the combustion outlet side 252, a fuel and air inlet side 256 and a side 258 that is opposite to the fuel and air inlet side 256, and sides 260, 262. The side 260, the side 258, and the side 254 are not visible in the perspective view of FIG. 4.

As will be appreciated, the first fuel cell stack 232 may include a plurality of fuel cells that are “stacked,” e.g., side-by-side from one end of the first fuel cell stack 232 (e.g., fuel and air inlet side 256) to another end of the first fuel cell stack 232 (e.g., side 258). As such, it will further be appreciated that the combustion outlet side 252 includes a plurality of combustion outlets 264, each from a fuel cell of the first fuel cell stack 232. During operation, combustion gas 266 (also referred to herein as “output products”) is directed from the combustion outlets 264 out of the housing 250. As described herein, the combustion gas 266 is generated using fuel and air that is not consumed by the fuel cells inside the housing 250 of the first fuel cell stack 232. The combustion gas 266 is provided to the combustion chamber 228 and burned during operation to generate combustion gasses used to generate thrust for the gas turbine engine 100 (and vehicle/aircraft incorporating the gas turbine engine 100).

The fuel and air inlet side 256 includes one or more fuel inlets 268 and one or more air inlets 270. Optionally, one or more of the inlets 268, 270 can be on another side of the housing 250. Each of the one or more fuel inlets 268 is fluidly coupled with a source of fuel for the first fuel cell stack 232, such as one or more pressurized containers of a hydrogen-containing gas or a fuel processing unit as described further below. Each of the one or more air inlets 270 is fluidly coupled with a source of air for the fuel cells, such as air that is discharged from a compressor section and/or an air processing unit as is also described further below. The one or more inlets 268, 270 separately receive the fuel and air from the external sources of fuel and air, and separately direct the fuel and air into the fuel cells.

In certain exemplary embodiments, the first fuel cell stack 232 of FIGS. 2 through 4 may be configured in a similar manner to one or more of the exemplary fuel cell systems (labeled 100) described in, e.g., U.S. Patent Application Publication No. 2020/0194799 A1, filed Dec. 17, 2018, that is incorporated by reference herein in its entirety. It will further be appreciated that the second fuel cell stack 234 of FIG. 2, may be configured in a similar manner as the first fuel cell stack 232, or alternatively may be configured in any other suitable manner.

Referring now to FIG. 5, operation of an integrated fuel cell and combustor assembly 200 in accordance with an exemplary embodiment of the present disclosure will be described. More specifically, FIG. 5 provides a schematic illustration of a gas turbine engine 100 and an integrated fuel cell and combustor assembly 200 according to an embodiment of the present disclosure. The gas turbine engine 100 and integrated fuel cell and combustor assembly 200 may, in certain exemplary embodiments, be configured in a similar manner as one or more of the exemplary embodiments of FIGS. 1 through 4.

Accordingly, it will be appreciated that the gas turbine engine 100 generally includes a fan section 102 having a fan 126, an LP compressor 110, an HP compressor 112, a combustion section 114, an HP turbine 116, and an LP turbine 118. The combustion section 114 generally includes the integrated fuel cell and combustor assembly 200 having a combustor 206 and a fuel cell assembly 204.

A propulsion system including the gas turbine engine 100 further includes a fuel delivery system 146. The fuel delivery system 146 generally includes a fuel source 148 and one or more fuel delivery lines 150. The fuel source 148 may include a supply of fuel (e.g., a hydrocarbon fuel, including, e.g., a carbon-neutral fuel or synthetic hydrocarbons) for the gas turbine engine 100. In addition, it will be appreciated that the fuel delivery system 146 also includes a fuel pump 272 and a flow divider 274, and the one or more fuel delivery lines 150 include a first fuel delivery line 150A, a second fuel delivery line 150B, and a third fuel delivery line 150C. The flow divider 274 divides the fuel flow from the fuel source 148 and fuel pump 272 into a first fuel flow through the first fuel delivery line 150A to the fuel cell assembly 204, a second fuel flow through the second fuel delivery line 150B also to the fuel cell assembly 204 (and in particular to an air processing unit, described below), and a third fuel flow through a third fuel delivery line 150C to the combustor 206. The flow divider 274 may include a series of valves (not shown) to facilitate such dividing of the fuel flow from the fuel source 148, or alternatively may be of a fixed geometry. Additionally, for the embodiment shown, the fuel delivery system 146 includes a first fuel valve 151A associated with the first fuel delivery line 150A (e.g., for controlling the first fuel flow), a second fuel valve 151B associated with the second fuel delivery line 150B (e.g., for controlling the second fuel flow), and a third fuel valve 151C associated with the third fuel delivery line 150C (e.g., for controlling the third fuel flow).

The gas turbine engine 100 further includes a compressor bleed system and an airflow delivery system. More specifically, the compressor bleed system includes an LP bleed air duct 276 and an associated LP bleed air valve 278, an HP bleed air duct 280 and an associated HP bleed air valve 282, an HP exit air duct 284 and an associated HP exit air valve 286.

The gas turbine engine 100 further includes an air stream supply duct 288 (in airflow communication with an airflow supply 290) and an associated air valve 292, which is also in airflow communication with the airflow delivery system for providing compressed airflow to the fuel cell assembly 204 of the integrated fuel cell and combustor assembly 200. The airflow supply may be, e.g., a second gas turbine engine configured to provide a cross-bleed air, an auxiliary power unit (APU) configured to provide a bleed air, a ram air turbine (RAT), etc. The airflow supply may be complimentary to the compressor bleed system if the compressor air source is inadequate or unavailable.

The compressor bleed system (and air stream supply duct 288) is in airflow communication with airflow delivery system for providing compressed airflow to the fuel cell assembly 204, as will be explained in more detail below.

Referring still to FIG. 5, the fuel cell assembly 204 of the integrated fuel cell and combustor assembly 200 includes a fuel cell stack 294, which may be configured in a similar manner as, e.g., the first fuel cell stack 232 described above. The fuel cell stack 294 is depicted schematically as a single fuel cell having a cathode side 296 (also referred to herein as “cathode 296”), an anode side 298 (also referred to herein as “anode 298”), and an electrolyte 300 (also referred to as an electrolyte layer) positioned therebetween. As will generally be appreciated, the electrolyte 300 may, during operation, conduct negative oxygen ions from the cathode side 296 to the anode side 298 to generate an electric current and electric power.

Briefly, it will be appreciated that the fuel cell assembly 204 further includes a fuel cell sensor 302 configured to sense data indicative of a fuel cell assembly operating parameter, such as a temperature of the fuel cell stack 294 (e.g., of the cathode side 296 or anode side 298 of the fuel cell), a pressure within the fuel cell stack 294 (e.g., of within the cathode side 296 or anode side 298 of the fuel cell), and/or a composition (e.g., a chemical composition) of the output products from the fuel cell assembly 204.

The anode side 298 may support electrochemical reactions that generate electricity. A fuel may be oxidized in the anode side 298 with oxygen ions received from the cathode side 296 via diffusion through the electrolyte 300. The reactions may create heat, steam, and electricity in the form of free electrons in the anode side 298, which may be used to supply power to an energy consuming device (such as the one or more additional electric devices 328 described below). The oxygen ions may be created via an oxygen reduction of a cathode oxidant using the electrons returning from the energy consuming device into the cathode side 296.

The cathode side 296 may be coupled to a source of the cathode oxidant, such as oxygen in the atmospheric air. The cathode oxidant is defined as the oxidant that is supplied to the cathode side 296 employed by the fuel cell system in generating electrical power. The cathode side 296 may be permeable to the oxygen ions received from the cathode oxidant.

The electrolyte 300 may be in communication with the anode side 298 and the cathode side 296. The electrolyte 300 may pass the oxygen ions from the cathode side 296 to the anode side 298, and may have little or no electrical conductivity, so as to prevent passage of the free electrons from the cathode side 296 to the anode side 298.

The anode side of a solid oxide fuel cell (such as the fuel cell stack 294) may be composed of a nickel/yttria-stabilized zirconia (Ni/YSZ) cermet. Nickel in the anode side serves as a catalyst for fuel oxidation and current conductor. During normal operation of the fuel cell stack 294, the operating temperature may be greater than or equal to about 700° C., and the nickel (Ni) in the anode remains in its reduced form due to the continuous supply of primarily hydrogen fuel gas.

The fuel cell stack 294 is disposed downstream of the LP compressor 110, the HP compressor 112, or both. Further, as will be appreciated from the description above with respect to FIG. 2, the fuel cell stack 294 may be coupled to or otherwise integrated with a liner of the combustor 206 (e.g., an inner liner 208 or an outer liner 210). In such a manner, the fuel cell stack 294 may also be arranged upstream of the combustion chamber 228 of the integrated fuel cell and combustor assembly 200, and further upstream of the HP turbine 116 and LP turbine 118.

As shown in FIG. 5, the fuel cell assembly 204 also includes a fuel processing unit 304 and an air processing unit 306. The fuel processing unit 304 may be any suitable structure for generating a hydrogen rich fuel stream. For example, the fuel processing unit 304 may include a fuel reformer or a catalytic partial oxidation convertor (CPOx) for developing the hydrogen rich fuel stream for the fuel cell stack 294. The air processing unit 306 may be any suitable structure for raising the temperature of air that is provided thereto to a temperature high enough to enable fuel cell temperature control (e.g., about 600° C. to about 800° C.). For example, in the embodiment depicted, the air processing unit includes a preburner system, operating based on a fuel flow through the second fuel delivery line 150B, configured for raising the temperature of the air through combustion, e.g., during transient conditions such as startup, shutdown and abnormal situations.

In the exemplary embodiment depicted, the fuel processing unit 304 and air processing unit 306 are manifolded together within a housing 308 to provide conditioned air and fuel to the fuel cell stack 294.

It should be appreciated, however, that the fuel processing unit 304 may additionally or alternatively include any suitable type of fuel reformer, including but not limited to a catalytic partial oxidizer, an autothermal reformer and steam reformer that may need an additional stream of steam inlet with higher hydrogen composition at the reformer outlet stream. Additionally, or alternatively, still, the fuel processing unit 304 may include a reformer integrated with the fuel cell stack 294. Similarly, it should be appreciated that the air processing unit 306 of FIG. 5 could alternatively be a heat exchanger or another device for raising the temperature of the air provided thereto to a temperature high enough to enable fuel cell temperature control (e.g., about 600° C. to about 800° C.).

As mentioned above, the compressor bleed system (and air stream supply duct 288) is in airflow communication with airflow delivery system for providing compressed airflow to the fuel cell assembly 204. The airflow delivery system includes an anode airflow duct 310 and an associated anode airflow valve 312 for providing an airflow to the fuel processing unit 304, a cathode airflow duct 314 and associated cathode airflow valve 316 for providing an airflow to the air processing unit 306, and a cathode bypass air duct 318 and an associated cathode bypass air valve 320 for providing an airflow directly to the fuel cell stack 294 (or rather to the cathode side 296 of the fuel cell(s)). The fuel delivery system 146 is configured to provide the first flow of fuel through the first fuel delivery line 150A to the fuel processing unit 304, and the second flow of fuel through the second fuel delivery line 150B to the air processing unit 306 (e.g., as fuel for a preburner system, if provided).

The fuel cell stack 294 outputs the power produced as a fuel cell power output 322. Further, the fuel cell stack 294 directs a cathode air discharge and an anode fuel discharge (neither labeled for clarity purposes) into the combustion chamber 228 of the combustor 206.

In operation, the air processing unit 306 is configured to heat/cool a portion of the compressed air, incoming through the cathode airflow duct 314, to generate a processed air to be directed into the fuel cell stack 294 to facilitate the functioning of the fuel cell stack 294. The air processing unit 306 receives the second flow of fuel from the second fuel delivery line 150B and may, e.g., combust such second flow of fuel to heat the air received to a desired temperature (e.g., about 600° C. to about 800° C.) to facilitate the functioning of the fuel cell stack 294. The air processed by the air processing unit 306 is directed into the fuel cell stack 294. In an embodiment of the disclosure, as is depicted, the cathode bypass air duct 318 and the air processed by the air processing unit 306 may combine into a combined air stream to be fed into a cathode of the fuel cell stack 294.

Further, as shown in the embodiment of FIG. 5, the first flow of fuel through the first fuel delivery line 150A is directed to the fuel processing unit 304 for developing a hydrogen rich fuel stream (e.g., optimizing a hydrogen content of a fuel stream), to also be fed into the fuel cell stack 294. As will be appreciated, and as discussed below, the flow of air (processed air and bypass air) to the fuel cell stack 294 (e.g., the cathode side 296) and fuel from the fuel processing unit 304 to the fuel cell stack 294 (e.g., the anode side 298) may facilitate electrical power generation.

Because the inlet air for the fuel cell stack 294 may come solely from the upstream compressor section without any other separately controlled air source, it will be appreciated that the inlet air for the fuel cell stack 294 discharged from the compressor section is subject to the air temperature changes that occur at different flight stages. By way of illustrative example only, the air within a particular location in the compressor section of the gas turbine engine 100 may work at 200° C. during idle, 600° C. during take-off, 268° C. during cruise, etc. This type of temperature change to the inlet air directed to the fuel cell stack 294 may lead to significant thermal transient issues (or even thermal shock) to the ceramic materials of the fuel cell stack 294, which could range from cracking to failure.

Thus, by fluidly connecting the air processing unit 306 between the compressor section and the fuel cell stack 294, the air processing unit 306 may serve as a control device or system to maintain the air processed by the air processing unit 306 and directed into the fuel cell stack 294 within a desired operating temperature range (e.g., plus or minus 100° C., or preferably plus or minus 50° C., or plus or minus 20° C.). In operation, the temperature of the air that is provided to the fuel cell stack 294 can be controlled (relative to a temperature of the air discharged from the compressor section) by controlling the flow of fuel to the air processing unit 306. By increasing a fuel flow to the air processing unit 306, a temperature of the airflow to the fuel cell stack 294 may be increased. By decreasing the fuel flow to the air processing unit 306, a temperature of the airflow to the fuel cell stack 294 may be decreased. Optionally, no fuel can be delivered to the air processing unit 306 to prevent the air processing unit 306 from increasing and/or decreasing the temperature of the air that is discharged from the compressor section and directed into the air processing unit 306.

Moreover, as is depicted in phantom, the fuel cell assembly 204 further includes an airflow bypass duct 321 extending around the fuel cell to allow a portion or all of an airflow conditioned by the air processing unit 306 (and combined with any bypass air through duct 318) to bypass the cathode side 296 of the fuel cell and go directly to the combustion chamber 228. The airflow bypass duct 321 may be in thermal communication with the fuel cell. The fuel cell assembly further includes a fuel bypass duct 323 extending around the fuel cell to allow a portion or all of a reformed fuel from the fuel processing unit 304 to bypass the anode side 298 of the fuel cell and go directly to the combustion chamber 228.

As briefly mentioned above, the fuel cell stack 294 converts the anode fuel stream from the fuel processing unit 304 and air processed by the air processing unit 306 sent into the fuel cell stack 294 into electrical energy, the fuel cell power output 322, in the form of DC current. This fuel cell power output 322 is directed to a power convertor 324 in order to change the DC current into DC current or AC current that can be effectively utilized by one or more subsystems. In particular, for the embodiment depicted, the electrical power is provided from the power converter to an electric bus 326. The electric bus 326 may be an electric bus dedicated to the gas turbine engine 100, an electric bus of an aircraft incorporating the gas turbine engine 100, or a combination thereof. The electric bus 326 is in electric communication with one or more additional electrical devices 328, which may be a power source, a power sink, or both. For example, the additional electrical devices 328 may be a power storage device (such as one or more batteries), an electric machine (an electric generator, an electric motor, or both), an electric propulsion device, etc. For example, the one or more additional electric devices 328 may include the starter motor/generator of the gas turbine engine 100.

Referring still to FIG. 5, the gas turbine engine 100 further includes a sensor 330. In the embodiment shown, the sensor 330 may be configured to sense data indicative of a flame within the combustion section 114 of the gas turbine engine 100, or some other parameter indicating an operating condition of the gas turbine engine. The sensor 330 may be, for example, a temperature sensor configured to sense data indicative of an exit temperature of the combustion section 114, an inlet temperature of the turbine section, an exhaust gas temperature, or a combination thereof. Additionally, or alternatively, the sensor 330 may be any other suitable sensor, or any suitable combination of sensors, configured to sense one or more gas turbine engine operating conditions or parameters, including data indicative of a flame within the combustion section 114 of the gas turbine engine 100.

Moreover, as is further depicted schematically in FIG. 5, the propulsion system, an aircraft including the propulsion system, or both, includes a controller 240. For example, the controller 240 may be a standalone controller, a gas turbine engine controller (e.g., a full authority digital engine control, or FADEC, controller), an aircraft controller, supervisory controller for a propulsion system, a combination thereof, etc.

The controller 240 is operably connected to the various sensors, valves, etc. within at least one of the gas turbine engine 100 and the fuel delivery system 146. More specifically, for the exemplary aspect depicted, the controller 240 is operably connected to the valves of the compressor bleed system (valves 278, 282, 286), the airflow delivery system (valves 312, 316, 320), and the fuel delivery system 146 (flow divider 274, valves 151A, 151B, 151C), as well as a sensor 330 of the gas turbine engine 100 and the fuel cell sensor 302. As will be appreciated from the description below, the controller 240 may be in wired or wireless communication with these components. In this manner, the controller 240 may receive data from a variety of inputs (including the gas turbine engine sensor 330 and the fuel cell sensor 302), may make control decisions, and may provide data (e.g., instructions) to a variety of output (including the valves of the compressor bleed system to control an airflow bleed from the compressor section, the airflow delivery system to direct the airflow bled from the compressor section, and the fuel delivery system 146 to direct the fuel flow within the gas turbine engine 100).

Referring particularly to the operation of the controller 240, in at least certain embodiments, the controller 240 can include one or more computing device(s) 332. The computing device(s) 332 can include one or more processor(s) 332A and one or more memory device(s) 332B. The one or more processor(s) 332A can include any suitable processing device, such as a microprocessor, microcontroller, integrated circuit, logic device, and/or other suitable processing device. The one or more memory device(s) 332B can include one or more computer-readable media, including, but not limited to, non-transitory computer-readable media, RAM, ROM, hard drives, flash drives, and/or other memory devices.

The one or more memory device(s) 332B can store information accessible by the one or more processor(s) 332A, including computer-readable instructions 332C that can be executed by the one or more processor(s) 332A. The instructions 332C can be any set of instructions that when executed by the one or more processor(s) 332A, cause the one or more processor(s) 332A to perform operations. In some embodiments, the instructions 332C can be executed by the one or more processor(s) 332A to cause the one or more processor(s) 332A to perform operations, such as any of the operations and functions for which the controller 240 and/or the computing device(s) 332 are configured, the operations for operating a propulsion system (e.g., method 500), as described herein, and/or any other operations or functions of the one or more computing device(s) 332. The instructions 332C can be software written in any suitable programming language or can be implemented in hardware. Additionally, and/or alternatively, the instructions 332C can be executed in logically and/or virtually separate threads on processor(s) 332A. The memory device(s) 332B can further store data 332D that can be accessed by the processor(s) 332A. For example, the data 332D can include data indicative of power flows, data indicative of gas turbine engine 100/aircraft operating conditions, and/or any other data and/or information described herein.

The computing device(s) 332 also includes a network interface 332E configured to communicate, for example, with the other components of the gas turbine engine 100 (such as the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302), the aircraft incorporating the gas turbine engine 100, etc. The network interface 332E can include any suitable components for interfacing with one or more network(s), including for example, transmitters, receivers, ports, controllers, antennas, and/or other suitable components. In such a manner, it will be appreciated that the network interface 332E may utilize any suitable combination of wired and wireless communications network(s).

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated that the gas turbine engine 100, the exemplary fuel delivery system 146, the exemplary integrated fuel cell and combustor assembly 200, and the exemplary fuel cell assembly 204 are provided by way of example only. In other embodiments, the integrated fuel cell and combustor assembly 200 and fuel cell assembly 204 may have any other suitable configuration. For example, in other exemplary embodiments, the fuel cell assembly 204 may include any other suitable fuel processing unit 304. Additionally, or alternatively, the fuel cell assembly 204 may not require a fuel processing unit 304, e.g., when the combustor of the gas turbine engine 100 is configured to burn hydrogen fuel and the fuel delivery assembly 146 is configured to provide hydrogen fuel to the integrated fuel cell and combustor assembly 200, and in particular to the fuel cell assembly 204.

Referring now to FIG. 6, a schematic view of a fuel cell assembly 400 having a fuel cell 402 in accordance with an exemplary embodiment of the present disclosure is provided. More particularly, the fuel cell assembly 400 may include a fuel cell stack having the fuel cell 402, with the fuel cell assembly 400 and fuel cell stack configured in a similar manner as one or more of the exemplary fuel cell assemblies 204 and fuel cell stacks 294 described above with reference to FIGS. 1 through 5.

In such a manner, it will be appreciated that the fuel cell assembly 400 may be operable with a propulsor of a propulsion system. For example, the fuel cell assembly 400 may be configured to provide electrical power to the propulsor, may be configured to provide output products to one or more portions of the propulsor, etc. More specifically, in at least one exemplary embodiment, the propulsor may be configured as a gas turbine engine having a combustion section with a combustor, and the fuel cell assembly 400 may be configured to provide output products to the combustor.

Alternatively, the exemplary fuel cell assembly 400 of FIG. 6 may be operable with any other suitable propulsor, such as an electric propulsor.

The exemplary fuel cell 402 includes an anode 404, a cathode 406, and an electrolyte layer 408 positioned between the anode 404 and the cathode 406. The anode 404 defines an anode inlet 410 and an anode outlet 412, and similarly the cathode 406 defines a cathode inlet 414 and a cathode outlet 416. During operation, a fuel flow 418 may be provided to the anode inlet 410 and an airflow 420 may be provided to the cathode inlet 414 to allow for the reactions required for the fuel cell 402 to generate electrical power. Also during operation, a flow of output products 422 from the cathode 406 may flow through the cathode outlet 416 and a flow of output products 424 from the anode 404 may flow through the anode outlet 412.

As will also be appreciated from the exemplary embodiment of FIG. 6, the exemplary fuel cell assembly 400 further includes a control system 426 having a controller 428 and a gas sensor 430. The controller 428 may be configured in a similar manner as the exemplary controller 240 described above with reference to FIG. 5. The gas sensor 430 is operably connected to the controller 428 such that the controller 428 may be configured to receive data from the gas sensor 430 (e.g., through a wired or wireless communication network). The gas sensor 430 is configured to sense gas composition data of the flow of output products 422 from the cathode 406, gas composition data of the flow of output products 424 from the anode 404, gas composition data of a fluid surrounding the fuel cell 402, or a combination thereof to determine fuel cell leakage diagnostic information.

More specifically, for the exemplary embodiment of FIG. 6, the gas sensor 430 is configured to sense gas composition of the flow of output products 424 from the anode 404. The gas sensor 430 is configured to sense the gas composition data in line with the flow of output products 424 from the anode 404, that is, the gas sensor 430 is configured to sense the gas composition data without requiring any gas to be siphoned off or diverted from the duct carrying the flow of output products 424. In particular, the gas sensor 430 includes a node 431 exposed to the flow of output products 424 from the anode 404.

The gas composition data may include a percentage of nitrogen (or rather nitrogen gas, N₂) in the output products 424 from the anode 404. Notably, for the embodiment shown, the fuel cell assembly 400 is further configured to sense data indicative of a flow rate of the output products 424 from the anode 404. More specifically, for the embodiment shown, the gas sensor 430 is configured to sense data indicative of the flow rate of output products 424 in the anode 404.

The sensed data relating to the percentage of nitrogen in the output products 424 from the anode 404 and the flow rate of the output products 424 from the anode 404 may be provided to the controller 428, and the controller 428 may be configured to determine the fuel cell leakage diagnostic information in response to such sensed data. For example, for the anode fuel composition without any nitrogen (such as when the fuel processing unit is configured as a steam reformer, rather than partial oxidizer), the presence of nitrogen in the output products 424 from the anode 404 may indicate a crossover leak 432A from the cathode 406 to the anode 404 (depicted in phantom in FIG. 6; the term “crossover leakage” is synonymous with “crossover leak”) as the fuel flow 418 provided to the anode 404 likely will not include any nitrogen. Similarly, an increase in the flow rate of the output products 424 from the anode 404, absent a corresponding increase in fuel flow 418 to the anode 404, may also indicate the crossover leak 432A from the cathode 406 to the anode 404.

For example, when a percentage of the nitrogen in the output products 424 from the anode 404 is greater than 0, such as greater than 0 and up to about 1%, such may indicate the crossover leak 432A from the cathode 406 to the anode 404. An alternative way for the diagnosis of a crossover leak 432A may be based on a trending of these detected gas compositions rather than their absolute values. If either the nitrogen gas concentration or an anode exhaust flowrate increases, the controller may determine the crossover leak 432A from the cathode 406 to the anode 404, and, e.g., provide an alert indicating the same.

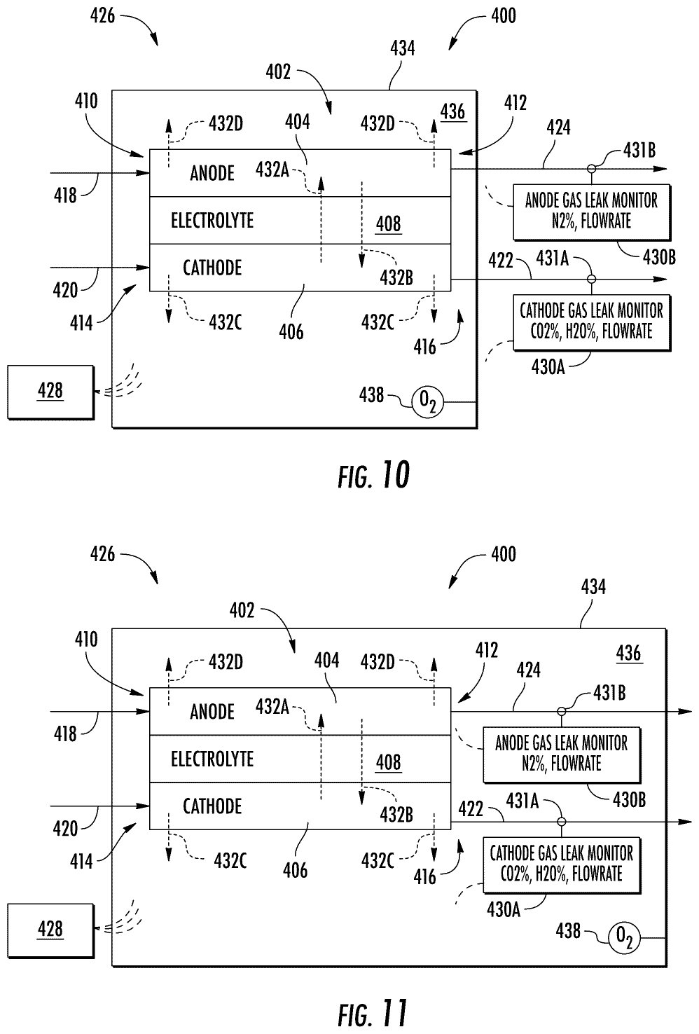

As will be described in more detail below, for the embodiment of FIG. 8 where the gas sensor 430 is configured to sense data indicative of a nitrogen content, the gas sensor 430 may use Raman spectroscopy, which is an optical analysis technique that relies on the measurement of the vibrational and rotational properties of molecules.

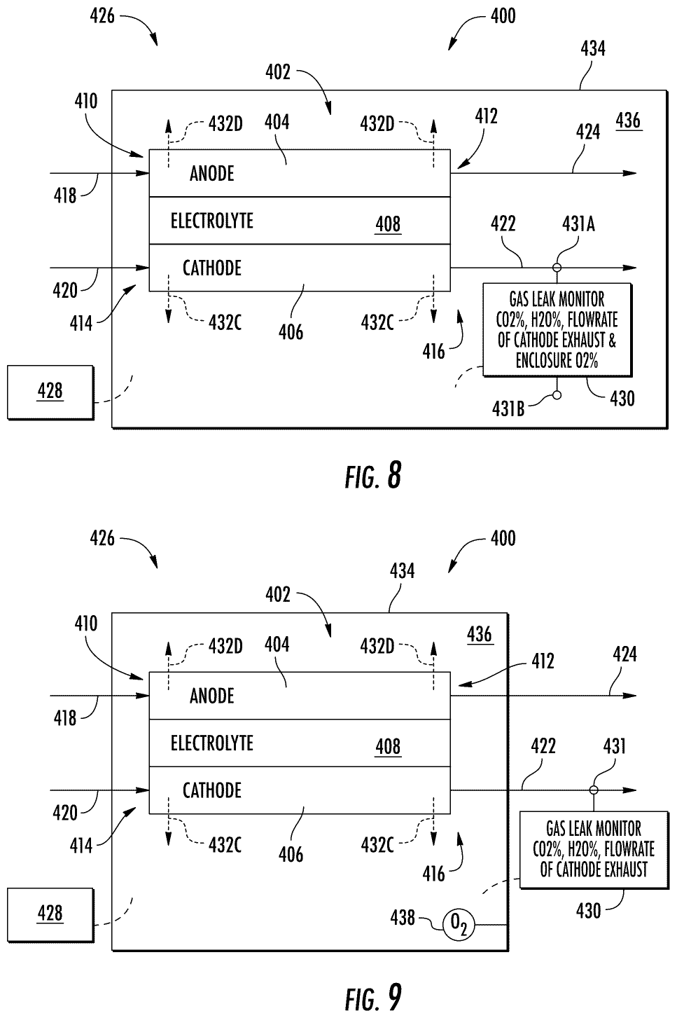

Referring now to FIG. 7, a fuel cell assembly 400 in accordance with another exemplary embodiment of the present disclosure is provided. The exemplary fuel cell assembly 400 of FIG. 7 may be configured in substantially the same manner as exemplary fuel cell assembly 400 described above with reference to FIG. 6. Accordingly, the same or similar numbers may refer to the same or similar parts.

For example, the exemplary fuel cell assembly 400 of FIG. 7 may generally include a fuel cell 402 having an anode 404, a cathode 406, and an electrolyte layer 408, as well as a control system 426 having a controller 428 and a gas sensor 430.

However, for the exemplary embodiment of FIG. 7, the gas sensor 430 is configured to sense gas composition data of the flow of output products 422 from the cathode 406, in line with the flow of output products 422 from the cathode 406. In particular, the gas sensor 430 includes a node 431 exposed to the flow of output products 422 from the cathode 406.

In certain exemplary aspects, the gas composition data may include a percentage of carbon dioxide (CO₂) in the output products 422 from the cathode 406, a percentage of H₂O in the output products 422 from the cathode 406, or both. Notably, for the embodiment shown, the fuel cell assembly 400 is further configured to sense data indicative of a flow rate of the output products 422 from the cathode 406. More specifically, for the embodiment shown, the gas sensor 430 is configured to sense data indicative of the flow rate of output products in the cathode 406.

The sensed data relating to the percentage of CO₂ and H₂O in the output products 422 from the cathode 406 and the flow rate of the output products 422 from the cathode 406 may be provided to the controller 428, and the controller 428 may be configured to determine the fuel cell leakage diagnostic information in response to such sensed data. For example, as will be explained in more detail below, the presence of carbon dioxide, H₂O, or both in the output products 422 from the cathode 406 may indicate a crossover leak 432B from the anode 404 to the cathode 406 (depicted in phantom in FIG. 7) as the airflow 420 provided to the cathode 406 likely will not include any carbon dioxide or H₂O and these are components that are present in the anode 404 during operation. Similarly, an increase in the flow rate of the output products 422 from the cathode 406, absent an increase in the flow rate of the airflow 420 provided to the cathode 406, may indicate the crossover leak 432B from the anode 404 to the cathode 406.

For example, when the percentage of carbon dioxide in the output products 422 from the cathode 406 is greater than 0, such as greater than 0 and up to about 1%, such may indicate the crossover leak 432B from the anode 404 to the cathode 406. Similarly, when the percentage of H₂O in the output products 422 from the cathode 406 is greater than 0, such as greater than 0 and up to about 5%, such as up to about 3%, such may also indicate the crossover leak 432B from the anode 404 to the cathode 406. An alternative way for the diagnosis of a crossover leak 432B from the anode 404 to the cathode 406 may be based on a trending of these detected gas compositions rather than their absolute values. For example, if any of a percentage of CO₂, a percentage of H₂O, or a flowrate of the output products 422 from the cathode 406 increases, the controller may determine the crossover leak 432B from the anode 404 to the cathode 406, and, e.g., provide an alert indicating the same.

Referring now to FIG. 8, a fuel cell assembly 400 in accordance with another exemplary embodiment of the present disclosure is provided. The exemplary fuel cell assembly 400 of FIG. 8 may be configured in substantially the same manner as exemplary fuel cell assembly 400 described above with reference to FIG. 7. Accordingly, the same or similar numbers may refer to the same or similar parts.

For example, the exemplary fuel cell assembly 400 of FIG. 8 may generally include a fuel cell 402 having an anode 404, a cathode 406, and an electrolyte layer 408, as well as a control system 426 having a controller 428 and a gas sensor 430 configured to sense gas composition data of the flow of output products 422 from the cathode 406, in line with the flow of output products 422 from the cathode 406. In particular, the gas sensor 430 includes a first node 431A exposed to the flow of output products 422 from the cathode 406.

However, for the embodiment of FIG. 8, it will be appreciated that the fuel cell assembly 400 further includes an enclosure 434 at least partially surrounding the fuel cell 402, and although not depicted, a fuel cell stack including the fuel cell 402. The enclosure 434 may be formed of one or more walls positioned around the fuel cell 402 (and fuel cell stack). For example, when the exemplary fuel cell 402 of FIG. 8 is incorporated into the fuel cell assembly 400 depicted in FIG. 2 and described above, the enclosure 434 may be positioned between the outer liner 210 and the outer casing 222 protect the fuel cell stack 232 from an airflow through the outer passageway 226 (see FIG. 2). The enclosure 434 may further assist with maintaining a temperature of the fuel cell 402 (and fuel cell stack) at a desired operating temperature.

Further, for the embodiment of FIG. 8, the gas sensor 430 is configured to sense gas composition data of a fluid 436 (e.g., gas) surrounding the fuel cell 402, and more specifically, of a fluid 436 surrounding the fuel cell 402 within the enclosure 434. For example, the gas composition data sensed by the gas sensor 430 may further include a percentage of oxygen (O₂) in the fluid 436 surrounding the fuel cell 402. In particular, the gas sensor 430 further includes a second node 431B exposed to the fluid 436 surrounding the fuel cell 402. In such a manner, it will be appreciated that the concentrations of CO₂ and H₂O within the output products 422 from the cathode 406 and the O₂ concentration in the fluid 436 surrounding the fuel cell 402 within the enclosure 434 are measured by a single sensor that has more than one electrical output and detects CO₂, H₂O, O₂ based on a multivariable sensor response. Such a configuration is further described below.

The sensed data relating to the percentage of oxygen in the fluid 436 surrounding the fuel cell 402 may also be provided to the controller 428, and the controller 428 may be configured to determine the fuel cell leakage diagnostic information further in response to such sensed data. For example, if the percentage of oxygen in the fluid 436 surrounding the fuel cell 402 is increasing, and further if the percentage of oxygen in the fluid 436 surrounding the fuel cell 402 is greater than a percentage of oxygen in the output products 422 from the cathode 406, then such may indicate an overboard leak 432C from the cathode 406, such as an upstream overboard leak proximate the cathode inlet 414 or a downstream overboard leak proximate the cathode outlet 416. Further for example, if the percentage of oxygen in the fluid 436 surrounding the fuel cell 402 is decreasing, and further if the percentage of oxygen in the fluid 436 surrounding the fuel cell 402 is less than a percentage of oxygen in the output products 422 from the cathode 406, then such may indicate an overboard leak 432D from the anode 404, such as an upstream overboard leak proximate the anode inlet 410 or a downstream overboard leak proximate the anode outlet 412.

Notably, for the embodiment of FIG. 8, the sensor 430 may determine a crossover leak 432B from the anode 404 to the cathode 406 in a similar manner as described above with reference to FIG. 7.

Referring now to FIG. 9, a fuel cell assembly 400 in accordance with another exemplary embodiment of the present disclosure is provided. The exemplary fuel cell assembly 400 of FIG. 9 may be configured in substantially the same manner as exemplary fuel cell assembly 400 described above with reference to FIG. 8. Accordingly, the same or similar numbers may refer to the same or similar parts.

For example, the exemplary fuel cell assembly 400 of FIG. 9 may generally include a fuel cell 402 having an anode 404, a cathode 406, and an electrolyte layer 408; a control system 426 having a controller 428 and a gas sensor 430; and an enclosure 434 at least partially surrounding the fuel cell 402.

However, for the embodiment of FIG. 9, the gas sensor 430 is positioned outside the enclosure 434, such that the gas sensor 430 is configured to sense gas composition data of the flow of output products 422 from the cathode 406 from a location outside the enclosure 434. In such a manner, the gas sensor 430 may be exposed to a less harsh environment, such as an environment having a lower temperature, pressure, or both during operation relative to a location inside the enclosure 434.

Notably with the configuration of FIG. 9, the control system 426 may include a dedicated sensor for sensing gas composition data within the enclosure 434. More specifically, for the embodiment of FIG. 9, the control system 426 includes a dedicated oxygen sensor 438 positioned within the enclosure 434 for sensing gas composition data within the fluid 436 surrounding the fuel cell 402, and more specifically a percentage of oxygen within the fluid 436 surrounding the fuel cell 402. The dedicated oxygen sensor 438 is in operable communication with the controller 428 to provide the gas composition data of the fluid 436 surrounding the fuel cell 402 to the controller 428 to allow the controller 428 to determine the fuel cell leakage diagnostic information.

Referring now to FIG. 10, a fuel cell assembly 400 in accordance with another exemplary embodiment of the present provided. The exemplary fuel cell assembly 400 of FIG. 10 may be configured in substantially the same manner as exemplary fuel cell assembly 400 described above with reference to FIG. 9. Accordingly, the same or similar numbers may refer to the same or similar parts.

For example, the exemplary fuel cell assembly 400 of FIG. 7 may generally include a fuel cell 402 having a cathode 406 and an anode 404; a control system 426 having a controller 428, a gas sensor 430 configured to sense gas composition data of the flow of output products 422 from the cathode 406, and a dedicated oxygen sensor 438; and an enclosure 434. The gas sensor 430 is positioned outside of the enclosure 434 and the dedicated oxygen sensor 438 is positioned inside the enclosure 434.

However, for the embodiment of FIG. 10, the gas sensor 430 is further configured to sense gas composition data of the flow of output products 424 from the anode 404. More specifically, for the exemplary embodiment depicted, the gas sensor 430 includes a first gas sensor 430A having a first node 431A configured to sense gas composition data of the flow of output products 422 from the cathode 406 and a second gas sensor 430B having a second node 431B configured to sense gas composition data of the flow of output products 424 from the anode 404.

Notably, the gas composition data from the first gas sensor 430A may be the same or similar gas composition data described above with reference to FIG. 7, and the gas composition data from the second gas sensor 430B may be the same or similar gas composition data described above with reference FIG. 6. In such a manner, the control system 426 may be configured to sense fuel cell leakage diagnostic information associated with a crossover gas leak 432B in the fuel cell 402 from the anode 404 to the cathode 406 (based on data sensed from the first gas sensor 430A); a crossover gas leak 432A in the fuel cell 402 from the cathode 406 to the anode 404 (based on data sensed from the second gas sensor 430B); an overboard gas leak 432D in the fuel cell 402 from the anode 404; an overboard gas leak 432C from the cathode 406; or any combination thereof.

It will be appreciated that for the exemplary embodiment of FIG. 10, the first gas sensor 430A and the second gas sensor 430B are each positioned outside of the enclosure 434 of the fuel cell assembly 400. In other exemplary embodiments, however, one or both of the first gas sensor 430A and the second gas sensor 430B may alternatively be positioned within the enclosure 434. For example, referring briefly to the embodiment of FIG. 11, which may be configured otherwise in substantially the same manner as exemplary embodiment of FIG. 10, the first gas sensor 430A and the second gas sensor 430B are positioned within the enclosure 434 of the fuel cell assembly 400.

Moreover, it will be appreciated that although for the exemplary embodiments of FIGS. 10 and 11, the fuel cell assembly 400, and more specifically, the control system 426, includes a first gas sensor 430A, a second gas sensor 430B, and a dedicated oxygen sensor 438, in other embodiments, two or more of these sensors may be formed integrally as a single sensor.

For example, referring briefly to FIG. 12, which may otherwise be configured in a similar manner as exemplary embodiment of FIG. 11, the fuel cell assembly 400 includes a control system 426 having a gas sensor 430 configured to sense gas composition data a flow of output products 424 from the anode 404, configured to sense gas composition data a flow of output products 422 from the cathode 406, and configured to sense gas composition data of a fluid 436 surrounding the fuel cell 402. In particular, for the embodiment of FIG. 12, the fuel cell assembly 400 includes the gas sensor 430 configured to sense gas composition data a flow of output products 422 from the cathode 406 through a first node 431A, configured to sense gas composition data a flow of output products 424 from the anode 404 through a second node 431B, and configured to sense gas composition data of a fluid 436 surrounding the fuel cell 402 through a third node 431C.

Further, for the embodiment of FIG. 12, the gas sensor 430 is positioned within the enclosure 434.

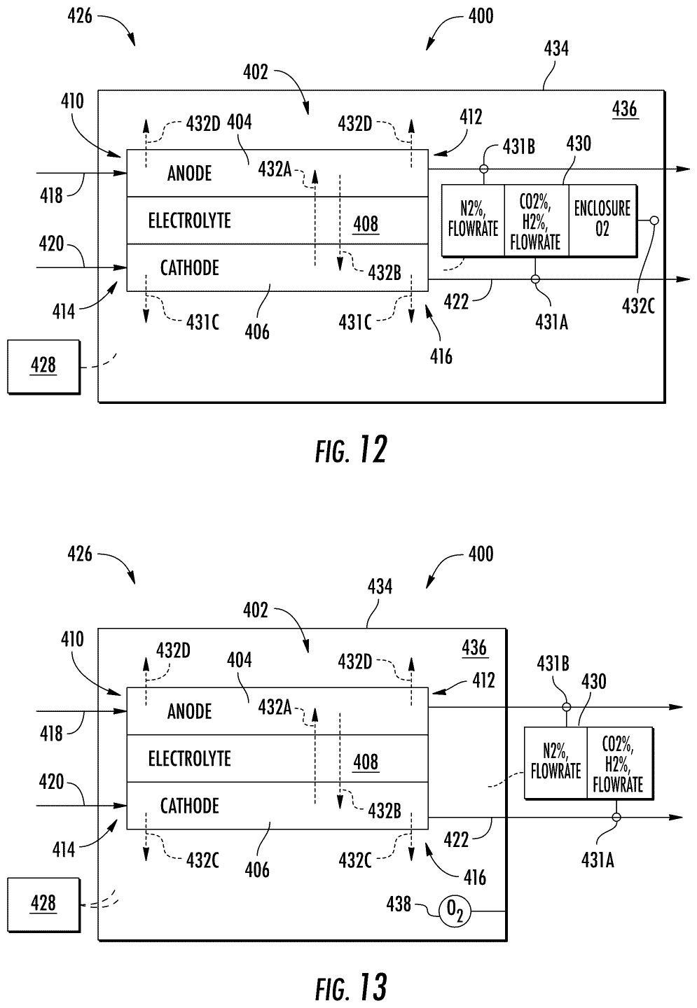

Also by way of example, referring briefly to FIG. 13, which may otherwise be configured in a similar manner as exemplary embodiment of FIG. 10, the fuel cell assembly 400 includes a control system 426 having a gas sensor 430 configured to sense gas composition data of a flow of output products 424 from the anode 404 and configured to sense gas composition data of a flow of output products 422 from the cathode 406. Further, for the embodiment of FIG. 13, the gas sensor 430 is positioned outside the enclosure 434, and the control system 426 further includes a dedicated oxygen sensor 438 positioned inside the enclosure 434.

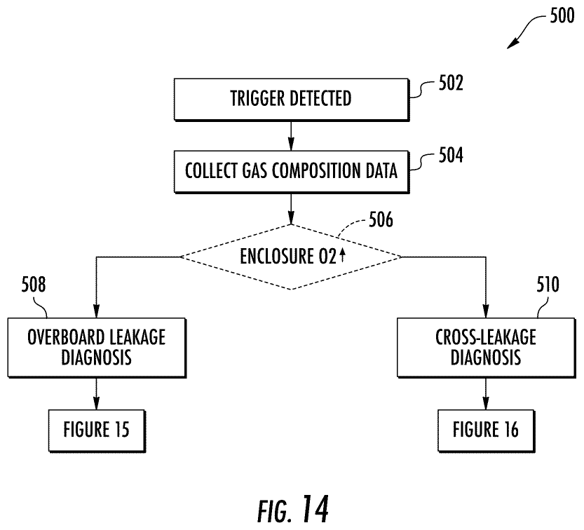

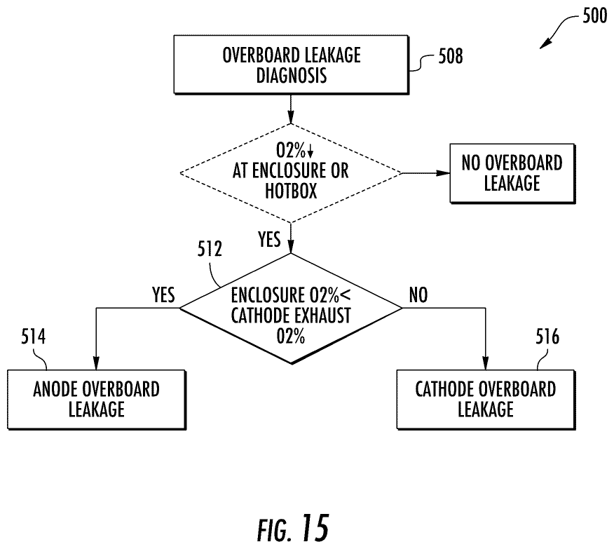

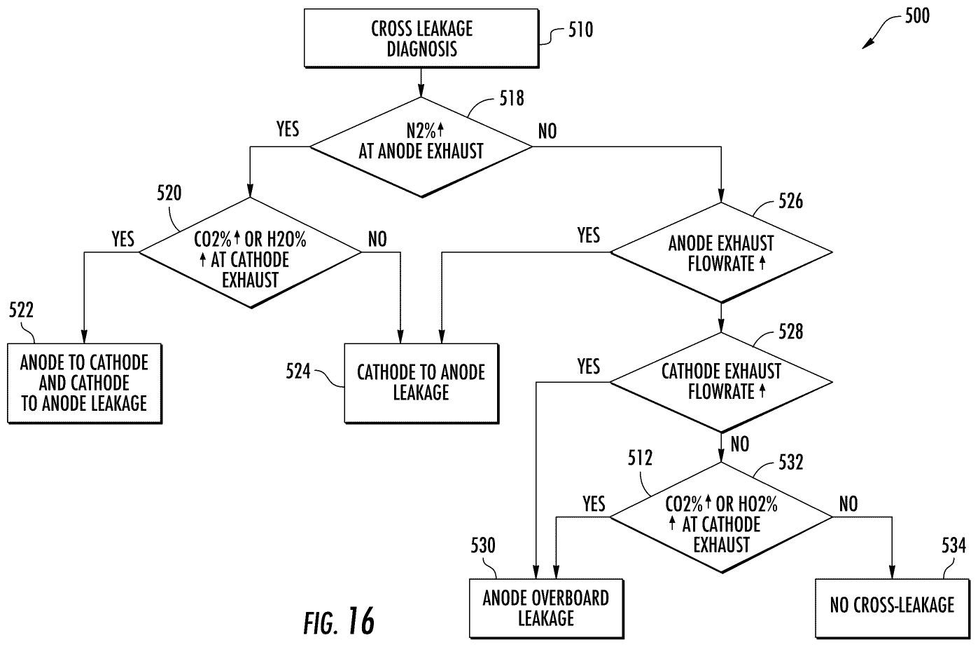

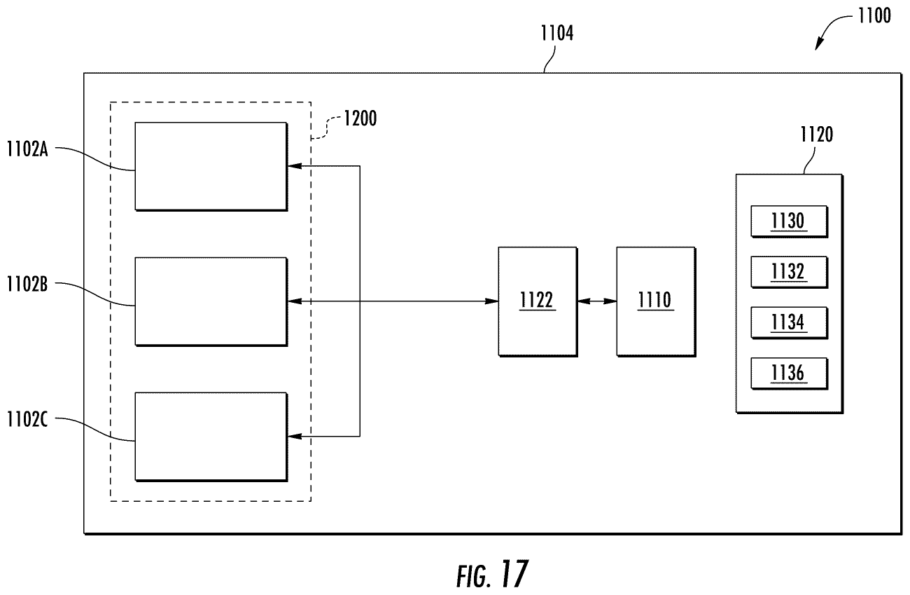

Referring now to FIG. 14, a flow diagram of a method 500 for determining fuel cell leakage diagnostic information in accordance with an exemplary aspect of the present disclosure is provided. The method 500 may be utilized with one or more of the exemplary fuel cells and fuel cell assemblies described above with reference to FIGS. 1 through 13. Accordingly, the method 500 may be utilized with a fuel cell assembly having a control system with a gas sensor configured to sense gas composition data of a flow of output products from a cathode of a fuel cell (of a fuel cell stack), gas composition data of a flow of output products from an anode of the fuel cell, gas composition data of a fluid surrounding the fuel cell, or a combination thereof.

The method 500 generally requires receiving from a gas sensor gas composition data of a flow of output products from the cathode, gas composition data of a flow of output products from the anode, gas composition data of a fluid surrounding the fuel cell, or a combination thereof; and determining fuel cell leakage diagnostic information in response to the received gas composition data.

More particularly, for the exemplary aspect of the method 500 depicted, the method 500 includes at (502) detecting a trigger. Detecting the trigger at (502) may include detecting an anomaly with the fuel cell assembly, such as detecting and an un-commanded change in voltage from the fuel cell and/or fuel cell stack, electrical resistance from the fuel cell and/or fuel cell stack, temperature of the fuel cell and/or fuel cell stack, pressure of one or more flow to or from the fuel cell and/or fuel cell stack or within the fuel cell and/or fuel cell stack, etc.

The method 500 further includes at (504) collecting gas composition data. In particular, for the aspect depicted, collecting gas composition data at (504) may be in response to the detected trigger at (502). Collecting the gas composition data at (504) may include collecting the gas composition data utilizing one or more sensors, such as a gas sensor (such as a multi-gas sensor), a dedicated oxygen sensor, etc.

The method 500 additionally includes at (508) initiating an overboard leakage diagnosis, and at (510) initiating a cross-leakage diagnosis. Aspects of the overboard leakage diagnosis initiated at (508) will be described in more detail below with reference to FIG. 15, and aspects of the cross-leakage diagnosis initiated at (510) will be described in more detail below with reference FIG. 16.

Notably, as is depicted in phantom, the method 500 may include at (506) determining from the collected gas composition data if a percentage of oxygen within an enclosure surrounding at least in part the fuel cell and fuel cell stack is increasing. If the percentage of oxygen within the enclosure is increasing as determined at (506), the method 500 may proceed with the initiating the overboard leakage diagnosis at (508), and if not, the method 500 may rule out an overboard leakage and proceed to the cross-leakage diagnosis at (510). Notably, even if the percentage of oxygen within the enclosure is increasing as determined at (506), the method may proceed to the cross-leakage diagnosis at (510).

Referring to FIG. 15, in response to initiating the overboard leakage diagnosis at (508), the method 500 further includes (512) determining from the collected gas composition data if a percentage of oxygen within the enclosure is greater than a percentage of oxygen within a flow of output products from the cathode. If the percentage of oxygen within the enclosure is less than the percentage of oxygen within the flow of output products from the cathode, as determined at (512), then the method 500 determines at (514) that the fuel cell is experiencing an anode overboard leakage. By contrast, if the percentage of oxygen within the enclosure is greater than the percentage of oxygen within the flow of output products from the cathode, as determined at (512), then the method 500 determines at (516) that the fuel cell is experiencing a cathode overboard leakage.

Referring now to FIG. 16, in response to initiating the cross-leakage diagnosis at (510), the method includes at (518) determining if a percentage of nitrogen within a flow of output products from the anode of the fuel cell is increasing or exceeds a threshold. If the percentage of nitrogen within the flow of output products from the anode is increasing or exceeds a threshold, as determined at (518), the method 500 further includes (520) determining if a percentage of carbon dioxide within the flow of output products from the cathode is increasing or exceeds a threshold, if a percentage of H₂O within the flow of output product from the cathode is increasing or exceeds a threshold, or both. If it is determined that one or both of the percentages of carbon dioxide or H₂O within the flow of output products from the cathode is increasing or exceeds a threshold at (520), then the method 500 includes at (522) determining that the fuel cell is experiencing an anode to cathode cross-leakage, as well as a cathode to anode cross-leakage.

In particular, an increasing percentage of nitrogen within the flow of output products from the anode, or a presence of nitrogen within the flow of output products from the anode in excess of a certain threshold, may indicate a cathode to anode cross-leakage, as nitrogen will not be part of the fuel provided to the anode of the fuel cell during operation of the fuel cell assembly. Similarly, an increasing percentage of carbon dioxide or H₂O within the flow of output products from the cathode, or a presence of carbon dioxide or H₂O within the flow of output products from the cathode in excess of a certain threshold, may indicate an anode to cathode cross-leakage, as neither carbon dioxide nor H₂O will be part of the airflow provided to the cathode of the fuel cell during operation of the fuel cell assembly.

Referring still to the exemplary aspect of the method 500 depicted in FIG. 16, it will be appreciated that in the event it is determined that neither the percentage of carbon dioxide nor the percentage of H₂O within the flow of output products from the cathode is increasing or exceeds a respective threshold, as determined at (520), then the method 500 may determine at (524) that the fuel cell is only experiencing a cathode to anode cross-leakage (due to the percentage of nitrogen within the flow of output products from the anode, as determined at (518)).

Further, in the event that it is determined that the percentage of nitrogen within the flow of output products from the anode is not increasing or does not exceed a threshold at (518) the method 500 may still check for a cathode to anode leakage at (526) by determining if a flow rate of the output products from the anode is increasing. If the flow rate of the output products from the anode is increasing, as determined (526), the method 500 may again determine that the fuel cell is experiencing a cathode to anode cross-leakage at (524).

After the determination at (526), regardless of whether the determination is “yes” or “no”, the method includes at (528) determining if a flow rate of the output products from the cathode is increasing. If the flow rate of the output products from the cathode is determined to be increasing at (528), then the method includes at (530) determining that the fuel cell is experiencing an anode to cathode cross-leakage.

In the event that it is determined that the flow rate of the output products from the cathode is not increasing at (528), then the method 500 includes at (532) determining if a percentage of H₂O, carbon dioxide, or both within the flow of output products from the cathode is increasing (similar to the determination at (520)). If the percentage of H₂O, carbon dioxide, or both is increasing, as determined at (532), then the method again includes at (530) determining that the fuel cell is experiencing an anode to cathode cross-leakage.

However, if it is determined that the percentage of percentage of H₂O, carbon dioxide, or both within the flow of output products from the cathode is not increasing at (532), then the method determines at (534) that the fuel cell is not experiencing a cross-leakage.

It will be appreciated that the exemplary method 500 described above with reference to FIGS. 14 through 16 is provided by way of example only. In other exemplary aspects of the present disclosure, the method 500 may not include each of the steps outlined above, and further may include the inquiries outlined above in any other suitable order. For example, in other example aspects where the method 500 is operable with a fuel cell assembly without the capability of sensing gas composition data of the flow of output products from the cathode, the method 500 may not include one or more of (520), (528), (532), etc. Similarly, in other exemplary aspects where the method 500 is operable with a fuel cell assembly without the capability of sensing gas composition data of the flow of output products from the anode, the method 500 may not include one or more of (518), (526). Further, in other exemplary aspects, where the method 500 is operable with a fuel cell assembly without the capability of sensing gas composition data of the fluid surrounding the fuel cell, the method may not include (508) or other aspects of the method 500 depicted in FIG. 15.

Similarly, as noted above, in other exemplary aspects, the method 500 may include the inquiries outlined above in any other suitable order. For example, in other exemplary aspects, one or more of (518), (520) and (532), (526), and (528) may be performed in parallel.

Moreover, as will further be appreciated from the description below, the method 500 may occur in real time. For example, in certain exemplary aspects, receiving the gas composition data (or collecting the gas composition data at (504)) may include receiving data at a resolution of 1 minute or less. For example, in certain exemplary aspects, receiving the gas composition data (or collecting the gas composition data at (504)) may more specifically include receiving data at a resolution of 30 seconds or less, such as 15 second or less, or 5 seconds or less. In such a manner, the gas sensor utilized at (504) may be configured to sense the gas composition data in real time. Moreover, it will be appreciated that when the gas sensor is configured in a similar manner as, e.g., one or more of FIGS. 6 through 13, collecting the gas composition data at (504) may be done in situ.

In such a manner, the method may be able to make control decisions based on data collected 1 minute beforehand or quicker.

It will be appreciated that the gas sensors described herein above may be any suitable gas sensor for detecting gas composition data of output products from a cathode of a fuel cell, gas composition data of a flow of output products from an anode of the fuel cell, gas composition data of a fluid surrounding the fuel cell, or a combination thereof.

In particular, in certain exemplary embodiments, the gas sensor may be configured to sense gas composition data of a single component of a fluid (e.g., a percentage of nitrogen within the flow of output products from the anode; see, e.g., FIG. 6). Such may allow for a more simple and cost effective leakage detection system, while still providing valuable fuel cell leakage and diagnostic information. Alternatively, the gas sensor may be configured to sense gas composition data of multiple components of a single fluid (e.g., a percentage of CO₂ and a percentage of H₂O within the flow of output products from the cathode; see, e.g., FIG. 7). Such a configuration may provide for a more versatile fuel cell leakage detection system, providing valuable fuel cell leakage and diagnostic information.

Alternatively, still, the gas sensor may be configured to sense gas composition data of one or more components of multiple fluids (e.g., a percentage of CO₂ and/or a percentage of H₂O within the flow of output products from the cathode, a percentage of nitrogen within the flow of output products from the anode, and/or a percentage of oxygen within the fluid surrounding the fuel cell; see, e.g., FIGS. 8, 12, and 13). Such a configuration may provide for an even more versatile fuel cell leakage detection system, providing valuable fuel cell leakage and diagnostic information.

In such a manner, it will be appreciated that the gas sensor may be a multi-gas sensor having multiple sensing nodes, configured to sense multiple unique responses (e.g., multiple unique electrical responses, vibrational responses, etc.), or the like.

For example, in on one exemplary embodiment, the gas sensor may use Raman spectroscopy, which is an optical analysis technique that relies on the measurement of the vibrational and rotational properties of molecules. Raman spectroscopy produces a unique spectral fingerprint that may identify chemical composition and molecular structure data fluids. Raman spectroscopy may utilize a laser directed to the fluid. A spectrometer collects and measures Raman scattered photons, creating a unique spectral fingerprint. A Raman measurement is nondestructive and can be collected in seconds (e.g., less than 10 seconds, less than 5 seconds, or less than 3 second, depending on the laser power and needed detection resolution). A Raman signal is straightforward to interpret: The distribution of the spectral peaks describes the molecule's composition while the signal intensity correlates linearly with concentration. Overlapping Raman peaks can be resolved using known data analytics techniques.

In certain exemplary aspects a gas sensor (multi-gas sensor or single gas sensor) configured to sense a percentage of nitrogen may utilize Raman spectroscopy, as such a technology may be well suited to determine nitrogen concentrations at the relatively low levels disclosed herein.

Additionally, or alternatively, in other exemplary embodiments, the gas sensor may utilize any other suitable technology. For example, referring now to FIG. 17, a gas sensor in accordance with another exemplary aspect of the present disclosure is provided. The gas sensor of FIG. 17 may be incorporated into one or more of the exemplary systems and methods described above with reference to FIGS. 11 through 16.

In particular, FIG. 17 illustrates one embodiment of a gas sensor configured as a multi-gas sensing system 1100 (i.e., a multi-gas sensor). The multi-gas sensing system 1100 examines fluid in contact with the system 1100. The fluid may be a gas, a liquid, a gas-liquid mixture, a solid, particles or particulate matter, or the like, containing one or more analyte gases therein to determine gas composition data.

The multi-gas sensing system 1100 may represent one or more different versions of sensing systems described herein. The system 1100 includes a sensing circuit 1200, a modifier assembly 1122, and a management circuit 1110 that may control operation of the modifier assembly 1122 and the sensing circuit 1200. In one or more embodiments, the sensing circuit 1200 may be a resistor-capacitor RC electrical circuit that includes one or more resistor R and capacitor C components that may be changed by the presence of one or more analyte gases of interest. For example, the management circuit 1110 may change the resistance and/or capacitance of the sensing circuit 1200. In one or more embodiments, the circuitry of the sensing system 1100 may be able to perform impedance measurements of the sensing system 1100 to determine an impedance response to one or more analyte gases of interest. Impedance measurements may be performed at one or more different frequencies or at one or more different RC configurations of the sensing circuit 1200. For example, the sensing circuit 1200 of the sensing system 1100 may measure impedance responses of the sensing system 1100 at different frequencies, at different resistances of the RC electrical circuit, at different capacitances of the RC electrical circuit, or any combination of two or more therein.

The term impedance as used herein may be a non-limiting term for any electrical response of the sensing system to an alternating electrical current applied to the sensing system. Such response may be measured as different electrical properties. Nonlimiting examples of these commonly measured different electrical responses of the sensing system to alternating electrical current include impedance, admittance, reactance, susceptance, or the like. In the present specification, examples of the responses are given as impedances, however, other electrical responses of the sensing system to alternating electrical current may be also equally produced.

In one embodiment, the electrical response of the sensing system may be monitored at the gas-modulated front shoulder of the dielectric relaxation peak of the sensing material.

Measurements of the impedance of the sensing system 1100 may be performed at a single frequency, at discrete frequencies, or at multiple scanned frequencies by an impedance analyzer or impedance analyzer circuit that may be a part of or coupled with the management circuit 1110 and/or a system controller 1120, and conductively coupled with the sensing circuit 1200. Optionally, the management circuit 1110 of the multi-gas sensing system 1100 may also or alternatively be called a spectrum analyzer, analyzer, alternating electrical current response analyzer, or the like.

In one or more embodiments, the impedance analyzer may be a part of the management circuit 1110 and may measure electrical responses of at least two sensing elements of the multi-gas sensing system, where the two sensing elements are based on different detection principles. A nonlimiting example of a first sensing element may be an electrode pair coated with a sensing material and positioned on a substrate. The impedance analyzer may measure the gas response of this first sensing element at frequencies or at a single frequency in the vicinity of the dielectric relaxation peak of the sensing material. A nonlimiting example of a second sensing element may be a mechanical resonator such as a tuning fork resonator, a thickness shear mode resonator, or a surface acoustic wave resonator, coated with a sensing material. The impedance analyzer may measure the resonant peak frequency position of this resonant second sensing element.

The multi-gas sensing system 1100 may include the system controller 1120. The system controller 1120 may include one or more devices such as, but not limited to, a power source 1130, a data analytics unit 1132, an output device 1134 (e.g., such as a safety alarm), and a communication system 1136. One or more of the components of the system controller 1120 may include one or more processors that include one or more microprocessors, field programmable gate arrays, and/or integrated circuits. In one or more embodiments, the sensing system 1100 may be a battery-operated device and/or may be powered using energy available from a main control system or by using harvesting of energy from ambient sources (e.g., light, vibration, heat, electromagnetic energy, or the like). In one or more embodiments, the management circuit 1110 and/or the modifier assembly 1122 may be a part of the system controller 1120. For example, the one or more processors of the system controller 1120 may operate in a manner similar to that as the management circuit 1110 and/or the modifier assembly 1122.

The data analytics unit 1132 may be in the form of an integrated circuit controller positioned on the same board as the sensing elements. As one example, the system 1100 may operate with a power demand of about 30 milliamp hour per hour of substantially continuous operation or less. The data analytics unit 1132 may receive data from one or more sensing elements 1102A-C directly or via the management circuit 1110, from other sensing elements such as temperature and/or ambient humidity sensing elements positioned on the same board. The data analytics unit 1132 may receive data wirelessly from one or more sensing elements 1102A-C directly or via the management circuit 1110, or from other sensing elements positioned at different locations in or around the system 1100, or the like.

The data may be stored in short term and/or long term memory storage devices, such as archiving communication systems, which may be located within or remote from the system 1100 and/or reconstructed and displayed for an operator, such as at an operator workstation, displayed via an output device of the system 1100, or the like. The data analytics unit 1132 may include one or more processors for analyzing the data received from the management circuit 1110. For example, the one or more processors may be one or more computer processors, controllers (e.g., microcontrollers), or other logic-based devices that perform operations based on one or more sets of instructions (e.g., software). The instructions on which the one or more processors operate may be stored on a tangible and non-transitory computer readable storage medium, such as a memory device. The memory device may include a hard drive, a flash drive, RAM, ROM, EEPROM, and/or the like. Alternatively, one or more of the sets of instructions that direct operations of the one or more processors may be hard-wired into the logic of the one or more processors, such as by being hard-wired logic formed and/or stored in the hardware of the one or more processors.

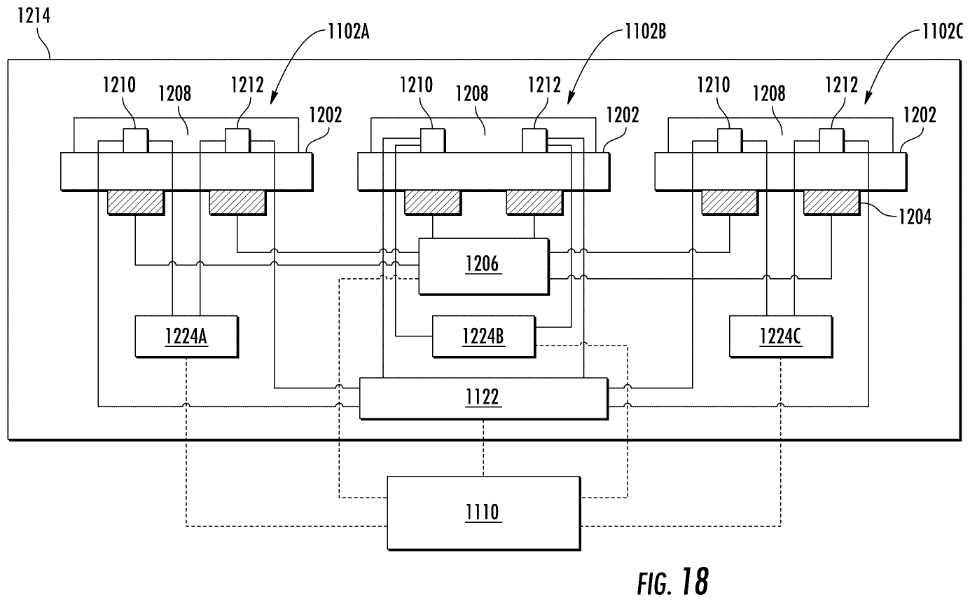

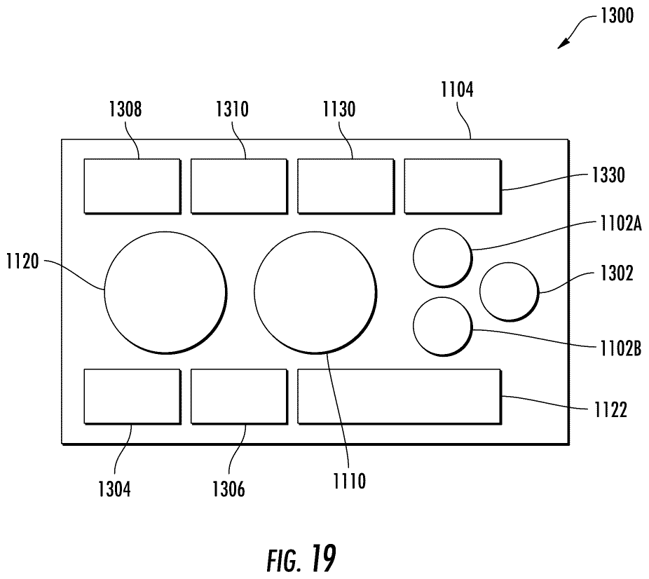

FIG. 18 illustrates one embodiment of the sensing circuit 1200 of the multi-gas sensing system 1100 of FIG. 1. The sensing circuit 1200 includes one or more sensing elements 1102A-C. Each of the sensing elements 1102A-C may be operationally in contact with a fluid that may contain one or more analyte gases therein. The sensing elements 1102A-C include a common substrate 1202, such as a dielectric material. Suitable materials of the substrate 1202 may include alumina, ceramics, and others. Each sensing element 1102A-C also includes a sensing film or sensing material 1208 that is coupled to the substrate 1202, and sensing electrodes 1210, 1212. Suitable examples of sensing materials or sensing films include a metal oxide material, a composite material, semiconducting materials, n-type semiconducting materials, p-type semiconducting materials, a combination of n-type and p-type semiconducting materials, nanocomposite materials, inorganic materials, any known sensing material capable operating at up to 900° C., or the like. Non-limiting examples of sensing materials operating at around 900° C. include gallium oxide and silicon carbide. Suitable electrodes may be formed using metal etching, screen-printing, ink-jet-printing, and mask-based metal deposition techniques. The thickness of fabricated electrodes on the substrates may be in the range from about 10 nanometers to about 1000 micrometers. The materials for the interdigital electrode structures, substrate, sensing layer, and electrode formation methods may be selected based at least in part on the application specific parameters.

The sensing material 1208 is exposed to, in contact with, in indirect contact with, or the like, at least one analyte gas. One or several heating elements 1204, such as high resistance bodies, are coupled to a different side of the substrate 1202 relative to the sensing material 1208. The heating elements 1204 receive electric current from a heater controller 1206, which represents hardware circuitry that conducts the heater current or voltage to the heating elements 1204 to heat the substrate 1202 and to heat the sensing film or sensing material 1208 that is coupled to another side of the substrate 1202. For example, in one or more embodiments of the inventive subject matter described herein, the sensing material 1208 utilizes a metal oxide sensing film. The management circuit 1110 may manage a temperature of each of the sensing elements 1102A-C by controlling operation of the heater controller 1206 to control each of the heating elements 1204. The sensing material 1208 can include one or more materials deposited onto the substrate 1202 to perform a function of predictably and reproducibly affecting the impedance sensor response upon interaction with the environment. For example, a metal oxide, such as gallium oxide and silicon carbide or any other material may be deposited as the sensing material 1208.

In one or more embodiments, one or more filters may be disposed over one or more of the sensing elements 1102A-C. For example, the one or more filters may be a barrier or alternative protection mechanism or device that may prohibit or reduce an amount of gaseous, liquid, and/or solid particles that may be in contact with the sensing material 1208, the sensing electrodes 1210, 1212, or the like. As one example, a single filter may be disposed over one or more elements, or alternatively individual sensing elements may include individual filters disposed over the top of the individual sensing elements. The one or more filters may be a gas-permeable membrane filter such that the filter may enable gases of interest to pass through the filter from one side to another, and may prohibit or reduce an amount of interferent gases or solid particles that may pass through the filter from one side to another. In one or more embodiments, the gas-permeable membrane filter may include a fluoropolymer or a fluoropolymer coating. Optionally, the filter may include an alternative coating such as a flame retardant.

The sensing electrodes 1210, 1212 of each sensing element 1102A-C are coupled with and/or disposed in the sensing material 1208 and are connected with the substrate 1202 in the illustrated embodiment. The sensing electrodes 1210, 1212 are conductive bodies that are conductively coupled with one or more of the modifier assembly 1122, transducers 1224A-C, and a management circuit 1110. In one or more embodiments, the transducers 1224A-C are electrode structures that are connected to an impedance detector system, and a sensor is a transducer that is coated with a sensing material. The management circuit 1110 may include an impedance detector system or a resistance detector system. Each of the modifier assembly 1122, the transducers 1224A-C, and the management circuit 1110 may have one or more processors that include one or more microprocessors, field programmable gate arrays, and/or integrated circuits.

In the illustrated embodiment of FIG. 18, each sensing element 1102A-C is operationally coupled with transducers 1224A-C, respectively. Alternatively, the sensing circuit 1200 may include a single transducer that is conductively coupled with each sensing element 1102A-C that may receive the electrical responses from each sensing element 1102A-C and convert variations of the electrical responses into a physical quantity.

In one or more embodiments, the sensing electrodes 1210, 1212 may be coated with a sensing material that is responsive to one or more analyte gases of interest. The one or more processors of the management circuit 1110 may direct the sensing electrodes 1210, 1212 to apply the electrical stimuli at one frequency, such as an electrical excitation frequency or a single excitation frequency. For example, the management circuit 1110 may excite the sensing elements 1102A-C with an alternating current at at least one predetermined frequency, at a predetermined frequency range, or the like.

The one or more processors of the management circuit 1110 may receive an electrical signal from the sensing electrodes 1210, 1212 of each sensing element 1102A-C that represents the electrical impedance or impedance response of the sensing elements 1102A-C during exposure of the sensing material 1208 to the fluid sample. For example, the one or more processors of the management circuit 1110 may measure the one or more electrical responses of the sensing elements 1102A-C responsive to exciting the sensing electrodes 1210, 1212 with the alternating electrical current at the at least one frequency or the frequency range.

The management circuit 1110 may determine one or more characteristics of the sensing circuit 1200 based on the electrical responses from each of the different sensing elements 1102. The characteristics of the sensing circuit 1200 may include a temperature of one or more of the sensing elements, a temperature variance between two or more sensing elements, a state of the sensing circuit 1200 based on a configuration of the sensing elements 1102, one or more ambient conditions (e.g., ambient temperature, humidity, or the like) within a predetermined area that is proximate the sensing circuit 1200, or the like. In one or more embodiments, the management circuit 1110 may manage a configuration of each of the one or more sensing elements, such that the management circuit 1110 may manage the resistor-capacitor configuration of at least one of the sensing elements. The management circuit 1110 may determine the state of the sensing circuit 1200 based on the resistor-capacitor configuration of each of the sensing elements of the sensing circuit. Optionally, the state of the sensing circuit 1200 may be based on another configuration of the sensing circuit.

In one or more embodiments, the management circuit 1110 may be referred to as a frequency impedance source and detector system. The management circuit 1110 examines the electrical impedance of the sensing elements 1102A-C in order to determine the presence and/or amount (e.g., concentration) of one or more analyte gases in the environment to which the sensing material 1208 of each sensing element 1102A-C is exposed, as described herein. The management circuit 1110 may provide scanning capability to measure sensor impedance responses at a single or at plural discrete frequencies. Alternatively, the system controller 1120 may provide capability to measure sensor impedance responses across a frequency range.

The sensing circuit 1200 may be operably coupled with the modifier assembly 1122 that may include a multiplexer. The multiplexer may be a single multi-frequency scanning signal analyzer that may operate with a power demand that is less than 10 milliwatts (mW), less than 5 mW, or in a more preferred embodiment, less than 1 mW. In one or more embodiments, each of the sensing elements 1102A-C may be conductively coupled with the modifier assembly 1122. The system controller 1120 and/or the management circuit 1110 may direct one or more of the sensing elements 1102A-C to change the impedance of the electrical stimuli applied to the corresponding sensing material 1208 without changing the excitation frequency. As one example, the modifier assembly 1122 may include a bank of circuits having plural circuits (not shown) to change the impedance of each of the sensing elements 1102A-C based on which circuits are electrically coupled with or electrically disconnected from the management circuit. Optionally, the modifier assembly 1122 may include a single circuit that may be a variable circuit or variable device that may change the impedance of each of the sensing elements 1102. In alternative embodiments, the modifier assembly may include a multiplexer having any alternative configuration, one or more circuits, or any combination therein.

The management circuit 1110 and/or the system controller 1120 may control the modifier assembly 1122 to apply the electrical stimuli to each of the sensing elements 1102A-C at single or discrete impedances, or at predetermined ranges of varying impedance, for interrogation of the sensing material 1208 of each respective sensing element 1102A-C and at what interrogation time to apply to measure the sensor response at each frequency. For example, the multiplexer of the modifier assembly may electrically connect and/or electrically disconnect one or more of the different sensing elements 1102A-C with the management circuit 1110 and the corresponding sensing electrodes 1210, 1212 to change which sensing elements 1102A-C of the sensing circuit 1200 are electrically coupled with and electrically disconnected from the modifier assembly 1122 and the management circuit 1110. For example, the modifier assembly 1122 may change the impedance of each of the sensing elements 1102A-C without changing the electrical excitation frequency of the electrical stimuli applied to the sensing electrodes 1210, 1212.

The multiplexer of the modifier assembly 1122 may combine the plural electrical response signals received from each of the sensing elements 1102A-C into a single output that is directed to the management circuit 1110. The management circuit 1110 receives the electrical response signals responsive to exciting the sensing electrodes 1210, 1212 at the alternating current at at least one predetermined frequency and determines the one or more characteristics of the sensing circuit 1200. The management circuit 1110 may transmit, or otherwise communicate, the electrical response signals and the determined characteristics of the sensing circuit 1200 to the one or more processors of the system controller 1120. A concentration of at least one gas analyte may be determined based on the electrical responses of the sensing elements 1102A-C and the characteristics of the sensing circuit 1200. For example, the data analytics unit 1132 of the system controller 1120 may convert sensor responses into the analytically useful gas composition data, e.g., concentrations of detected gases. Additionally, the data analytics unit 1132 may determine a concentration of at least one gas analyte based on one or more temperatures of each of the sensing elements, the ambient conditions proximate the sensing circuit 1200 (e.g., within a predetermined proximity or area of the sensing circuit, such as within 1 meter, 5 meters, 10 meters, 100 meters, or the like), or the like.

As one example, the system controller 1120 may determine the concentration of at least one analyte gas based on electrical responses from two or more different sensing elements (e.g., sensing elements 1102A, 1102B). The first sensing element 1102A may be operated at a first substantially constant temperature and the second sensing element 1102B may be operated at a different, second substantially constant temperature. For example, the management circuit 1110 may control the heating elements 1204 such that the first sensing element 1102A may operate at a first temperature, and that the second sensing element 1102B may operate at a different temperature that may be greater than or less than the first temperature.

As another example, the system controller 1120 may determine the concentration of the one or more gas analytes based on electrical responses from two or more different sensing elements, such as sensing elements 1102A and 1102B. The management circuit 1110 may control operation of the heating elements 1204 to operate the first sensing element 1102A at periodically variable temperatures and may operate the second sensing element 1102B at different periodically variable temperatures. For example, the heating elements 1204 may change a temperature of the first sensing element 1102A (e.g., such as within a temperature range) that increases and/or decreases the temperature to predetermined values at predetermined times, for predetermined durations, or any combination therein. Additionally, the heating elements 1204 may change a temperature of the second sensing element 1102B (e.g., within a different or the same temperature range), that increases and/or decreases the temperature to different predetermined values at different predetermined times, for different predetermined durations, or any combination therein. Optionally, the first and second sensing elements 1102A, 1102B may operate at similar temperature ranges for different durations, may operate at similar durations but at different temperature ranges, may operate at similar temperatures and durations but at different times, or the like.

The sensing elements 1102A-C including the sensing material 1208 and substrate 1202, the heating elements 1204, the heater controller 1206, the modifier assembly 1122, and the transducers 1224A-C are disposed within a common housing 1214. The common housing 1214 may be operably coupled with the substrate or a circuit board 1104 (see FIG. 18) of the system 1100. Optionally, one or more sensing elements 1102A-C may be disposed in individual housings to separate each sensing element from each other sensing element. Optionally, one or more of the modifier assembly 1122, the heater controller 1206, one or more of the transducers 1224, or the management circuit 1110 may be operably coupled with the circuit board 1104 of the system 1100 and may be disposed outside of or separate from the common housing 1214. Optionally, one or more of the components of the system 1100 may be disposed or contained within housings together with or separate from any other components of the system 1100.

FIG. 19 illustrates a system layout of a multi-gas sensing system 1300 in accordance with one embodiment. The components and devices of the system 1300 are disposed on the substrate or circuit board 1104. In one or more embodiments, one or more of the components or devices of the system 1300 may be disposed on one or both sides of the circuit board 1104. The system 1300 may include one or more power devices or components such as the power source 1130 or power switch, a power regulator, a nonvolatile memory or other memory or storage device 1306, a charging source 1308, such as a micro-USB or the like, or a charger or charging device 1310. In one or more embodiments, the power source 1130 may be or include a battery source, or any alternative untethered power source. The system 1300 may include processing components such as the management circuit 1110, the system controller 1120, and the modifier assembly 1122. The management circuit 1110 may include one or more processors that include one or more microprocessors, field programmable gate arrays, and/or integrated circuits that may operate or function as an impedance analyzer, a resistor detector system, or the like. The system controller 1120 may include one or more processors that may operate as a data analytics unit, a memory system (e.g., memory 1306), or the like. The modifier assembly 1122 is illustrated as separate from the system controller 1120 and the management circuit 1110, but alternatively may be included with one or both of the management circuit 1110 or the system controller 1120.

The system 1300 includes two different sensing elements 1102A, 1102B. In one or more embodiments, the sensing elements 1102A, 1102B may each be designed to sense or otherwise detect the presence of one or more of nitrogen (N₂), oxygen (O₂), carbon dioxide (CO₂), water (H₂O), methane (CH₄), carbon monoxide (CO), or the like. Optionally, the different sensing elements may be designed to sense or otherwise detect different gases. The system 1300 includes a sensing element 1302 that may be designed to sense or otherwise detect ambient conditions, such as ambient temperature, ambient humidity, ambient pressure, or the like. For example, the sensing elements 1102A, 1102B may communicate electrical responses to the management circuit 1110 responsive to the management circuit exciting the sensing elements 1102A, 1102B with the alternating current at the at least one predetermined frequency. The management circuit 1110 may measure the electrical responses from the sensing elements 1102A, 1102B to determine one or more characteristics of the sensing circuit. Additionally, the sensing element 1302 may detect ambient conditions of an area proximate the system 1100, and the management circuit 1110 may determine characteristics of the system 1100 based on the ambient conditions detected by the sensing element 1302. The one or more processors of the system controller 1120 may receive the electrical responses and the characteristics of the sensing circuit and determine a concentration of at least one gas analyte, such as a gas analyte of interest, based on the electrical responses and the characteristics of the sensing circuit.

In one or more embodiments, the system 1300 may include an output device 1304. As one example, the output device 1304 may be illustrated as LED lights. For example, the LED lights may illuminate based on the electrical responses of the sensing elements, based on characteristics of the of the sensing circuit, or the like. Optionally, the output device 1304 may be any alternative safety device that may illuminate, sound an alarm, vibrate, or otherwise communicate to an operator of the system 1100 if the system controller 1120 determines that a gas of interest exceeds a predetermined threshold.

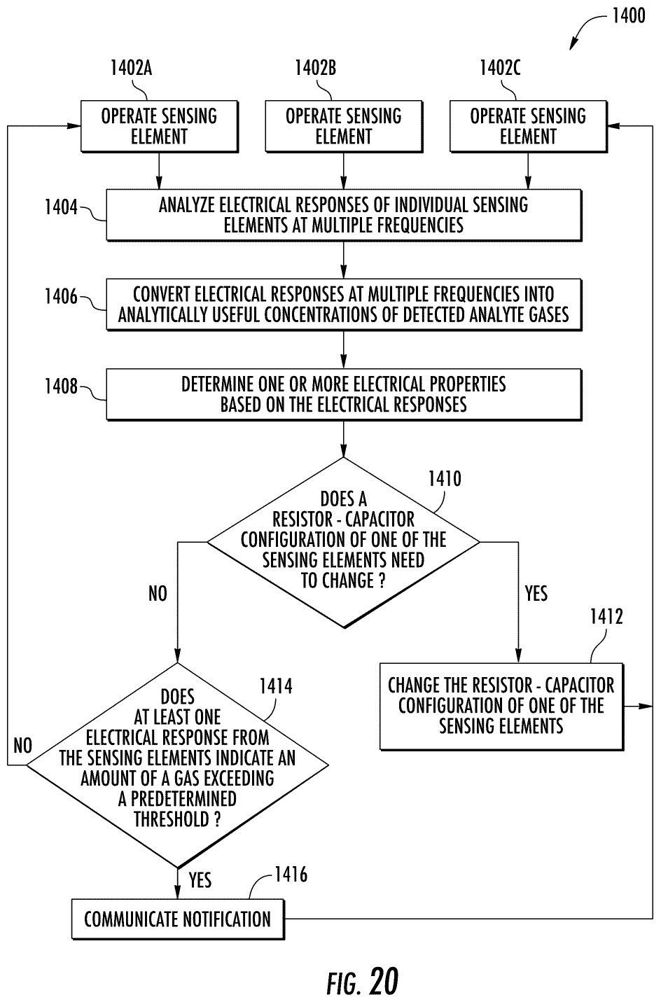

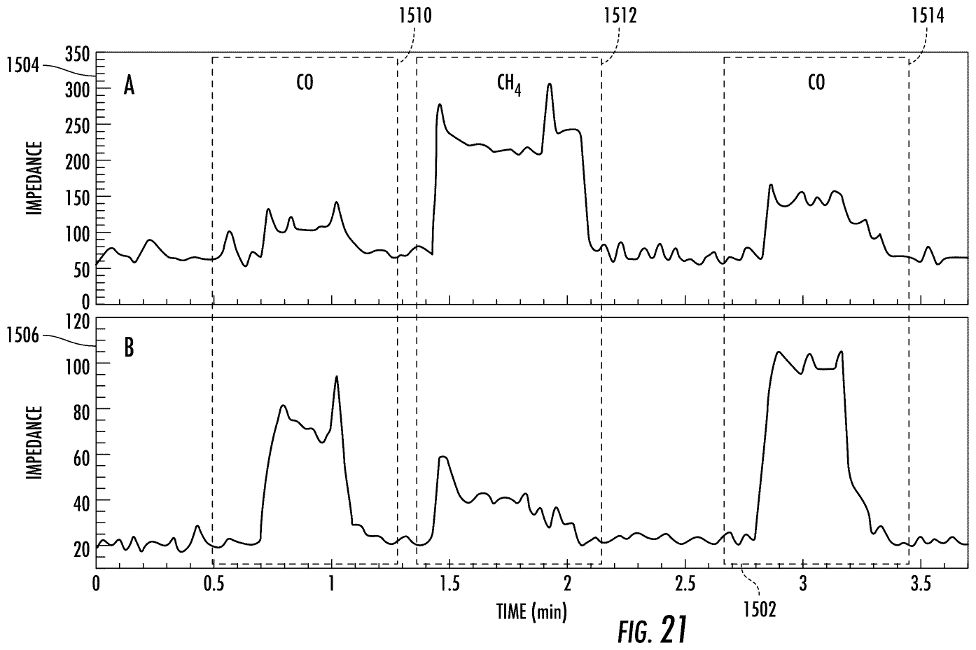

FIG. 20 illustrates a flowchart 1400 of one embodiment of a method for sensing multiple different gas analytes using a multi-gas sensing system in accordance with one embodiment. The multi-gas sensing system may be the system illustrated in FIG. 17. At 1402A-C, each of the sensing elements 1102A-C may be operated. For example, the management circuit may excite each of the sensing elements with an alternating current at at least one predetermined frequency. The management circuit may excite sensing element 1102A at a first predetermined frequency, and may excite the sensing elements 1102B, 1102C at different, unique or common frequencies relative to each other and the sensing element 1102A. Optionally, one or more of the sensing elements 1102A-C may be excited at a predetermined frequency range. In the illustrated embodiment of FIGS. 17 and 18, the system includes three sensing elements. Alternatively, the system may include less than three or more than three sensing elements. Alternatively, the system may include only one sensing element.

In one or more embodiments, the management circuit may manage a temperature of one or more of the sensing elements by controlling a heating element. For example, the management circuit may control operation of the heating element such that one or more of the sensing elements are operated at a predetermined temperature, are operated at a predetermined temperature range, such that the different sensing elements are operated at different temperatures or at a range of different temperatures, or the like. In one embodiment, the management circuit may control the heating element to periodically change the temperature of the first sensing element 1102A and to substantially maintain a temperature of the second and third sensing elements 1102B, 1102C. For example, the management circuit may control the heating element such that the first sensing element 1102A is operated at a first constant or first variable temperature, and the second sensing element 1102B is operated at a different, second constant temperature or second variable temperature. As another example, the management circuit may control the heating element such that the first sensing element 1102A is operated at periodically variable temperatures, and the second sensing element 1102B is operated at different periodically variable temperatures. The different periodically temperatures of the second sensing element may be substantially the same temperatures, but heated at different periodic times than the first sensing element. Alternatively, the first and second sensing elements may be heated at substantially the same or common periodic times, but the first sensing element may be heated to temperatures that are different than the temperatures of the second sensing element.

The management circuit may synchronize the temperature of one or more sensing elements with the excitation of the one or more sensing elements. For example, the management circuit may synchronize controlling the heating elements to control a temperature of one or more sensing element to a predetermined at substantially the same time, or within a predetermined time window, as exciting the one or more sensing elements at the alternating current of the predetermined frequency. For example, the management circuit may control the heating elements and excite the one or more sensing elements at substantially the same time, within a time window, or the like. Optionally, the management circuit may synchronize changing a temperature of the one or more sensing elements with a duration of excitation of the sensing elements. Optionally, the management circuit may synchronize substantially maintaining a temperature range of the one or more sensing elements while variably exciting the sensing elements at the predetermined frequency or frequency range. Optionally, the management circuit may otherwise synchronize the temperature of the sensing elements with the excitation of the sensing elements in any alternative configuration or based on one or more predetermined rules.

At 1404, the one or more processors of the management circuit and/or the system controller may analyze the electrical responses from the sensing elements responsive to the excitation of the sensing electrodes of the sensing elements. The electrical responses may be represented as signal outputs from each of the one or more sensing elements. An alternating electrical current may be applied to each of the one or more sensing elements at one or more different frequencies, or at one or more different resistor-capacitor configurations of each of the sensing elements. For example, the first sensing element may have a first resistor-capacitor configuration, and a first frequency may be applied to the sensing electrodes of the first sensing element to excite the first sensing element. Alternatively, the second sensing element may have a second, different resistor-capacitor configuration, and a different, second frequency may be applied to the sensing electrodes of the second sensing element. Alternatively, one or more of the sensing elements may have common resistor-capacitor configurations, or a common frequency may be applied to excite one or more of the sensing elements.

FIG. 21 illustrates graphical illustrations of electrical responses of individual sensing elements of a multi-gas sensing system in accordance with one embodiment. Graph A represents the electrical responses from a first sensing element that may be designed to detect the presence of methane (CH₄). Graph B represents the electrical responses from a second sensing element that may be designed to detect the presence of carbon monoxide (CO). Alternatively, the electrical responses may be received from a single sensing element that may be configured to operate to detect the presence of CH₄, CO, and any other gas. Graphs A and B are illustrated having a common horizontal axis 1502 representative of time, and vertical axes 1504, 1506, respectively, representative of the impedance of the sensing circuit 1200.

Measurements of one or more of the real Z′ or imaginary Z″ parts of the impedance of the sensing circuit 1200 may be performed within a dielectric relaxation region of the sensing circuit 1200. The dielectric relaxation region of the sensing system 1100 may be a range of frequencies within a designated threshold of the measured impedance of the sensing circuit 1200 at the occurrence of relaxation peak and/or a relaxation point frequency or an inflection point frequency range of the imaginary Z″ part of the impedance. For example, the relaxation peak (also known as relaxation frequency) may be identified as the location along the imaginary part of an impedance spectra at which the impedance response changes from being concave to convex, or changes from being convex to concave. The inflection point frequency is the frequency or the frequency range at which the inflection point occurs. Alternatively, the inflection point can be determined be examining the real part of the measured impedance of the sensing material 1208 to locate where the curvature of the real part of the impedance changes from a concave shape to a convex shape, or from a convex shape to a concave shape. In one or more embodiments, the electrical response of the sensing system is monitored at the gas-modulated front shoulder of the dielectric relaxation peak of the semiconducting sensing material. For an n-type semiconducting sensing material, the front-edge shoulder may be the high-frequency region of the relaxation peak. For a p-type semiconducting sensing material, the front-edge shoulder may be the low-frequency region of the relaxation peak.

As one example, the sensing circuit may be exposed to about 11.36% volume of CH₄ and 1090 parts per million (ppm) of CO. As illustrated in Graphs A and B, the second sensing element (e.g., the CO sensor) detects an increase in the impedance in the presence of CO as illustrated in a first section 1510, but the first sensing element (e.g., the CH₄ sensor) indicates only a minimal increase in impedance in the presence of CO. Similarly, the second sensing element detects an increase in the presence of CO as illustrated in a third section 1514, but the first sensing element has only a minimal increase. Alternatively, the first sensing element detects an increase in impedance in the presence of CH₄ as illustrated in a second section 1512, but the second sensing element has only a minimal increase. Graphs A and B illustrate discrimination between the CH₄ and CO by the first and second sensing elements of the sensing circuit.

Returning to FIG. 20, at 1406, the electrical responses at multiple frequencies received from one or more sensing elements are converted into analytically useful concentrations of detected analyte gases, and at 1408 one or more electrical properties are determined based on the electrical responses. For example, the management circuit and/or the data analytics unit of the system 1100 may perform analysis on the electrical responses received from the sensing elements to determine one or more concentrations of the one or more sensed analyte gases. The analysis may be based on one or more of the electrical responses of the sensing elements; characteristics of the sensing circuit such as, but not limited to, temperatures of the sensing elements, states of the sensing circuit based on configurations of the sensing elements, ambient conditions proximate the sensing circuit, or the like; or any combination of two or more therein. In one or more embodiments, the analysis may be based on one or more of the sensing elements being operated at periodically variable temperatures, one or more sensing elements being operated at common or unique substantially constant temperatures, different discrete frequencies or frequency ranges used to excite the sensing elements, or the like.

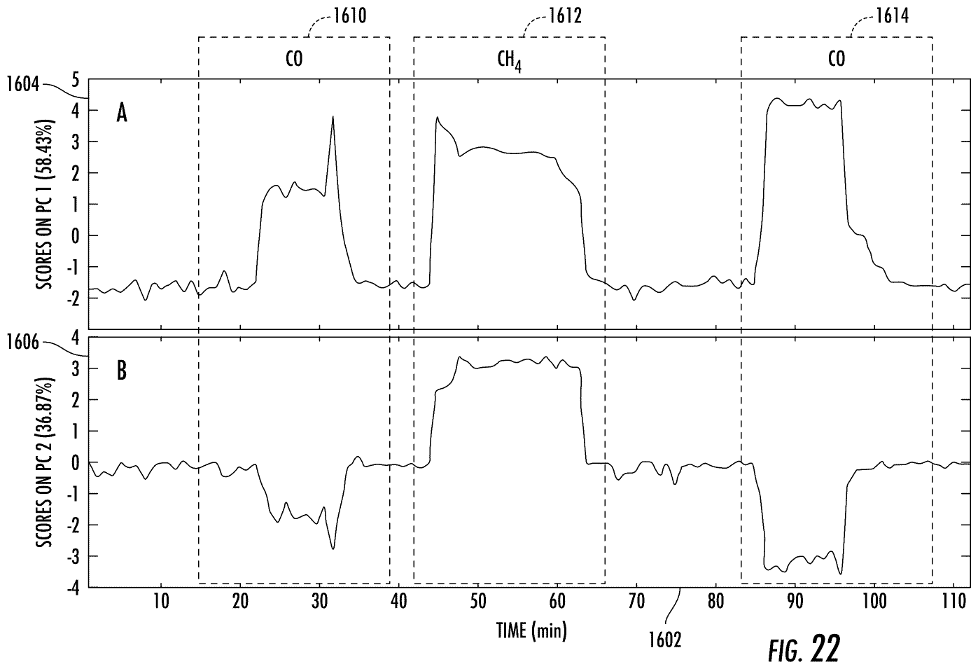

For example, FIG. 22 illustrates graphical illustrations of the results of analyzed data of electrical responses of two sensing elements of the multi-gas sensing system shown in FIG. 21.

The electrical responses may be evaluated using one or more different statistical analysis tools, such as, for example, by performing Principal Component Analysis (PCA) on the electrical responses and other characteristics obtained by the system controller. Optionally, the concentration of one or more gases may be computed from a multivariable transfer function that may be built based on the electrical responses to the alternating electric current of the management system, temperatures of the sensing elements, states of the resistor-capacitor configurations of the sensing elements, information about environmental conditions around the multi-gas sensing system from the sensing circuit or other sensors, or the like. Optionally, alternative statistical analysis may be used to evaluate the data obtained by the system controller.

Graph A represents the results of analyzed data of the combined electrical responses using PCA and presented as the scores of the Principal Component #1 as a function of experimental time.

Graph B represents the results of analyzed data of the combined electrical responses using PCA and presented as the scores of the Principle Component #2 as a function of experimental time.

Graphs A and B are illustrated having a common horizontal axis 1602 representative of experimental time, and vertical axes 1604, 1606, respectively, representative of a linear scale of Principal Component #1 and Principal Component #2, respectively, of the developed PCA classification.

As illustrated in Graph A, first and third sections 1610, 1614, indicate the increased concentrations of CO, and a second section 1612 indicates the increased concentration of CH₄. For example, the first and third sections indicate the PCA Principal Component #1 responses to CO gas (e.g., sections 1510, 1514 of Graph B) of FIG. 21, and the second section indicates the PCA Principal Component #1 response to CH₄ gas (e.g., section 1512 of Graph A) of FIG. 21.

As illustrated in Graph B, first and third sections 1610, 1614 indicate the increased concentrations of CO, and a second section 1612 indicates the increased concentration of CH₄. For example, the first and third sections indicate the PCA Principal Component #2 responses to CO gas (e.g., sections 1510, 1514 of Graph B) of FIG. 21, and the second section indicates the PCA Principal Component #2 response to CH₄ gas (e.g., section 1512 of Graph A) of FIG. 21.

In one or more embodiments, the one or more processors of the system controller may provide a baseline correction of the sensing elements. The baseline correction may be done periodically, at scheduled intervals (e.g., after so many minutes, hours, days, years, or the like, of operating), or the like. The baseline correction may also be referred to as calibration of the sensing elements. The amount of correction, or the method of correcting or verifying the baseline, may be based on the electrical responses received from the sensing elements, the temperatures of the sensing elements, the state of the resistor-capacitor configurations of the sensing elements, information about the environmental conditions (e.g., ambient temperature, humidity, pressure, or the like) around or proximate to the multi-gas sensing system, based information received from other sensors or sensing devices, based on information wirelessly communicated to the multi-gas sensing system (e.g., such as from a workstation separate from the multi-gas sensing system), based on information or a protocol stored within the multi-gas sensing system, or the like.

Optionally, the one or more processors may change a selectivity, sensitivity, or linearity of the electrical responses of the multi-gas sensing system 1100 to allow the system to be more responsive to one analyte gas versus another analyte gas at different times or under different operating conditions. In one or more embodiments, the one or more processors may dynamically change the selectivity, the sensitivity, or the linearity, such that the one or more processors may change one or more of the selectivity, the sensitivity, or the linearity while the sensing system is operating. Optionally, the one or more processors may change one or more of the selectivity, the sensitivity, or the linearity of the electrical responses of the sensing system when the system is not sensing. For example, the one or more processors may determine a relaxation region of an impedance response of the sensing circuit. Both the real part of the impedance and the imaginary part of the impedance have a relaxation region. As one example, this relaxation region can be determined by examining the real part of the measured impedance of the sensing material 1208 as a function of frequency to locate where the real part of the impedance changes from high impedance value with substantially zero slope at low frequencies, to decreasing impedance values with a relatively high slope at higher frequencies, and to decreasing impedance values with a relatively low slope at even higher frequencies, and where impedance values are approaching zero at the highest frequencies.

The one or more processors may determine a position of the relaxation peak of the relaxation region of the imaginary part of the sensor impedance by identifying the inflection point frequency of the sensing circuit 1200. The inflection point frequency can be determined as the frequency of the electric current associated with the inflection point.

The one or more processors may determine frequency ranges of sensor operation that are lower and higher than the relaxation peak of the imaginary part of the sensor impedance and that are at or about (e.g., within 11%, within 3%, within 5%, or within 110% in different embodiments) the relaxation peak of the imaginary part of the sensor impedance. An electric current may be applied to the sensing material 1208 via the electrodes 1210, 1212 of one or more sensing elements only at frequencies that are greater than the inflection point frequency and/or that are within the range of frequencies that are greater than the inflection point frequency. Operating the sensing circuit 1200 at these frequencies can improve the selective sensing of the sensing circuit 1200 (e.g., the sensitivity of the sensing circuit 1200) to one or more analytes of interest in the second sample relative to one or more other analytes (and relative to operating the sensing circuit 1200 at a frequency or frequencies that are at or below the inflection point frequency). The sensitivity of the sensing circuit 1200 includes a measured sensor response signal per analyte concentration unit.

As another example, the one or more processors may selectivity sense at least one analyte of interest with improved suppressed effects of interferences. Resistance and capacitance properties of the sensing circuit 1200 are measured during exposure of the sensing circuit 1200 to a first gas sample and are measured during exposure of the sensing circuit 1200 to a second gas sample. The one or more processors determine a capacitance value or a range of capacitance values of one or more passive electrical components (e.g., capacitive elements) in order to change a capacitance of one or more sensing elements of the sensing circuit 1200 to match a frequency range or a discrete frequency response of the system controller within a dielectric relaxation region of the sensing circuit 1200. Changing the capacitance of the sensing circuit 1200, that is coupled with the system controller, allows the system controller to selectively sense an analyte of interest (e.g., methane, ethane, another hydrocarbon, hydrogen, carbon monoxide, or the like) with suppressed effects of interferences.

Selective sensing of one or more analytes of interest is performed using the sensing circuit 1200 operating within a dielectric relaxation region of the sensing circuit in order to match a discrete frequency response or a frequency response range of the system controller 1120. For example, the sensing material 1208 of each sensing element of the sensing circuit 1200 can be exposed to a gas sample potentially having one or more analytes of interest therein. The system controller 1120 can communicate a control signal to the management circuit 1110 to direct the management circuit 1110 to apply alternating electric current to the sensing material 1208 via the sensing electrodes 1210, 1212 either over a designated frequency response range or at the designated discrete frequency of the system controller 1120 that is within the dielectric relaxation region of the sensing circuit 1200. Operating the sensing circuit 1200 at these frequencies can increase the selective sensing of the multi-gas sensing system 1100 (e.g., the sensitivity of sensing of the sensing system 1100) to one or more analytes of interest in the sample relative to one or more other analytes (and relative to operating the sensing circuit 1200 at a different frequency or different frequency range of the system controller 1120). The sensitivity of the sensing circuit 1200 includes a measured sensor response signal per analyte concentration unit.

Returning to FIG. 20, a determination is made if a resistor-capacitor configuration of one of the sensing elements needs to change. If the configuration does need to change, the flow of the method proceeds towards 1412, where the management circuit changes the resistor-capacitor configuration of one or more sensing elements. Flow of the method then returns to 1402A-C where the method starts again. Alternatively, if the resistor-capacitor configuration of none of the sensing elements needs to change, flow of the method moves toward 1414.

At 1414, a determination is made if an amount of at least one gas exceeds a predetermined threshold. For example, the system controller may determine that, based on the analysis performed in steps 1404 through 1408, that there is an amount of gas present that exceeds a predetermined threshold and the concentration of the gas may be dangerous to the operator or user of the multi-gas sensing system. Optionally, the concentration of the gas may be dangerous for an operator to perform a particular task such as, but not limited to, drive or operate motorized equipment, use inflammatory equipment, remain in the environment without wearing appropriate safety equipment, or the like. In one or more embodiments, a determination may be made if any amount of a particular gas is present. For example, any trace amount, or a minimal amount of a particular gas may be dangerous for the operator to continue operating or to remain in the environment.

In one or more embodiments, the one or more processors of the system controller may determine a responsive action of an asset based on the electrical responses by the multi-gas sensing system. For example, the system controller may determine whether the concentration of at least one gas analyte exceeds a predetermined threshold at 1414.

If the amount or concentration of the gas analyte does not exceed a predetermined threshold, the flow of the method returns to 1402A-C and the method repeats for a predetermined amount of time, while the operator is within the environment, until the operator disables the multi-gas sensing system, or the like. Alternatively, if the amount or concentration of the gas exceeds a predetermined threshold, flow of the method proceeds toward 1416. At 1416, a notification is communicated to at least the controller or other system incorporating the multi-gas sensing system.

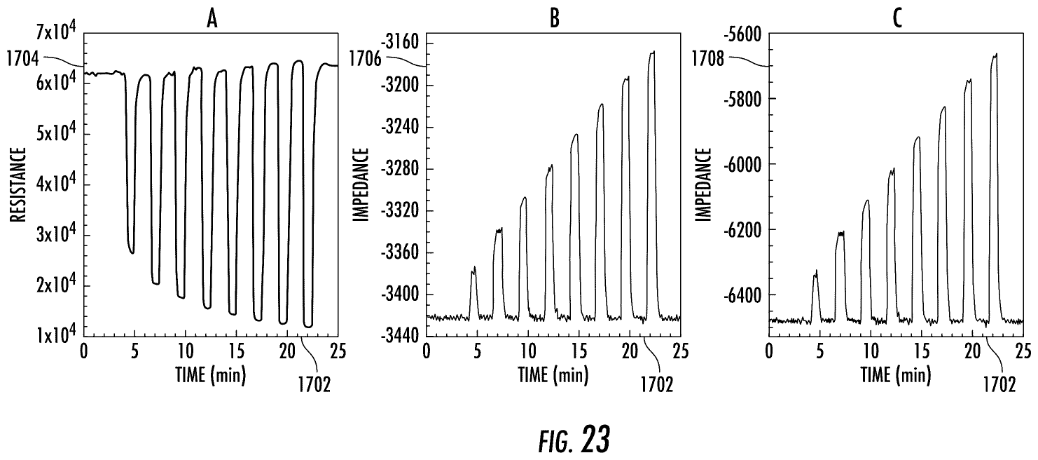

FIG. 23 illustrates graphical illustrations of responses of a metal oxide sensing element to a gas of interest, such as methane, according to one experiment. In the present experiment, the sensing element is a structure with an integrated heater formed on a silicon substrate using micro-electromechanical systems (MEMS) technology and a metal-oxide semiconductor material layer formed on the sensing chip as a surface-mount ceramic package. The sensing element requires a heater power consumption of only about 15 mW. In the present experiment, methane was presented to the sensing element at concentrations of 1087 parts per million (ppm), 2174 ppm, 3261 ppm, 4348 ppm, 5435 ppm, 6522 ppm, 7609 ppm, and 8696 ppm.

Graphs A, B, and C are illustrated having a common horizontal axis 1702 representative of experimental time. Graph A is illustrated having a vertical axis 1704 representative of resistance, and Graphs B and C are illustrated having vertical axes 1706, 1708, respectively, representative of impedance. Graph A of FIG. 23 depicts the electrical response of the sensing element as measured by conventional resistance. The resistance response of the sensing element to methane concentrations has a non-linear response. Additionally, the sensitivity decreases with the increase of methane gas concentration. Graphs B and C illustrate the electrical response of the sensing element as measured by the dielectric excitation methodology. Results illustrated in Graph B were achieved by using a desktop impedance analyzer. Results illustrated in Graph C were achieved using an integrated circuit impedance analyzer. The close resemblance of the linearity of the responses and the noise levels in Graphs B and C demonstrate that the quality of sensing of methane using the integrated circuit impedance analyzer was approximately the same when compared to the quality of sensing of methane using the desktop impedance analyzer.

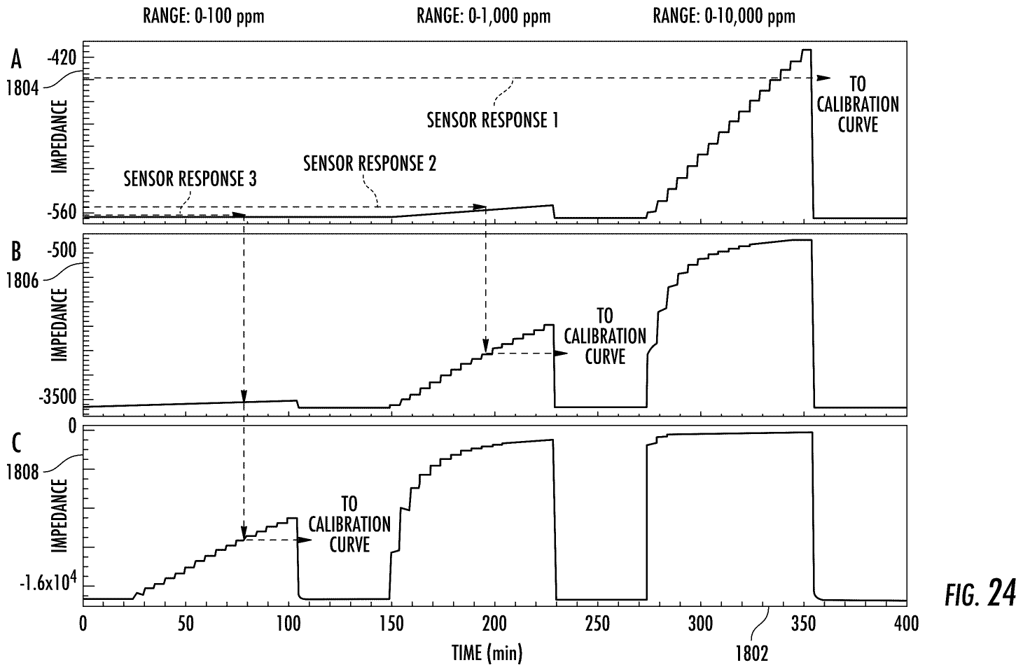

The developed sensor system may measure electrical responses of the sensing element responsive to alternating electrical current applied to the sensing element at one or more different frequencies and/or one or more different resistor-capacitor configurations, of the sensing element. To quantify a gas of interest over its broad range of concentrations with a linear sensor response and its desired resolution, the dielectric excitation methodology can be applied at several frequencies. FIG. 24 illustrates graphical illustrations of three measured sensor responses at three frequencies (Graphs A, B, and C) ranging from relatively high to medium and to relatively low frequency. The Graphs A, B, and C are illustrated having a common horizontal axis 1802 representative of experimental time, and vertical axes 1804, 1806, 1808 representative of impedance.

While responses can be measured at all three frequencies of the measurement system, to determine a gas concentration, the calibration curve can be started at the highest frequency. If the sensor response is above the approximately bottom 20% of the sensor responses at this frequency (e.g., sensor response #1), the linear calibration curve at this frequency can be noted and can be related to the gas concentration (Graph A). If the sensor response is below the bottom 20% of the sensor responses at this frequency (e.g., sensor responses #2 and #3), detection can be switched to a decade lower in gas concentrations by using the linear calibration curve at the lower frequency and relating the sensor response to the gas concentration (e.g., sensor response #2, show in Graph B). If the sensor response 3 is below the approximate 10% of the sensor responses at this frequency, detection can be switched further to a decade lower in gas concentrations and the corresponding calibration curve can be utilized (e.g., Graph C). Thus, these sensor responses at different frequencies can allow high-resolution determination of gas concentrations across the broad range of gas concentrations with linear response.

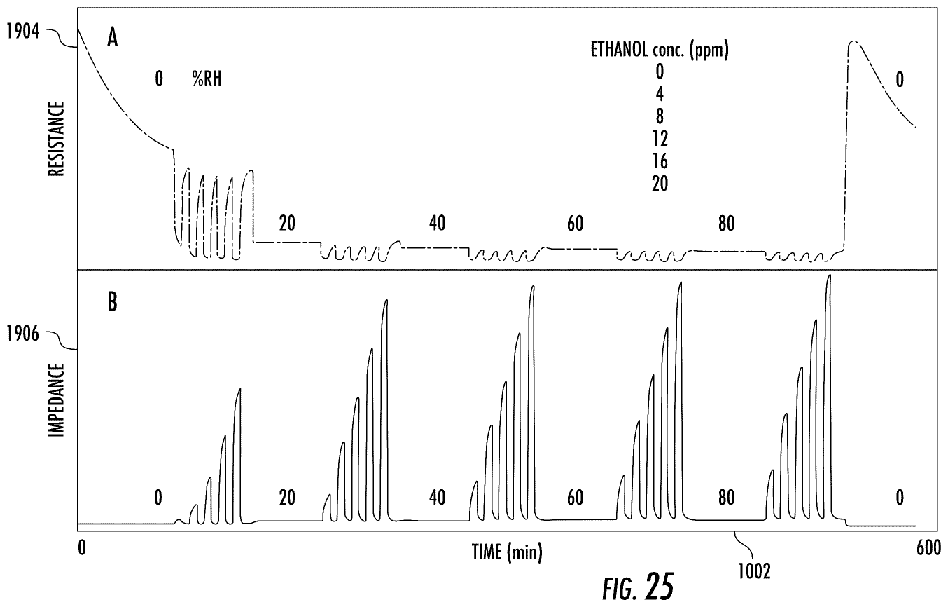

Another experiment demonstrated that variable humidity of air affects the response of conventional chemiresistor sensors based on metal oxide sensing materials by changing their baseline and gas sensitivity. For example, FIG. 25 illustrates effects of water vapor over a range of 0-80% relative humidity (RH) on resistance and impedance (dielectric response) responses to ethanol (as a model vapor) at concentrations of 4, 8, 12, 16, and 20 ppm. Graphs A and B are illustrated having a common horizontal axis 1002 representative of experimental time. Graph A is illustrated having a vertical axis 1904 representative of resistance, and Graph B is illustrated having a vertical axis 1906 representative of impedance.

The resistance response had a known significant decrease in baseline and decrease in gas sensitivity with the increase of RH (Graph A). Meanwhile, the dielectric excitation and impedance measurement can provide three advancements over resistance measurements (illustrated in Graph B). First, response baseline can be less affected by humidity variations. Second, sensor sensitivity can be increased with the increase of RH. Third, response linearity can be improved in the presence of water vapor.

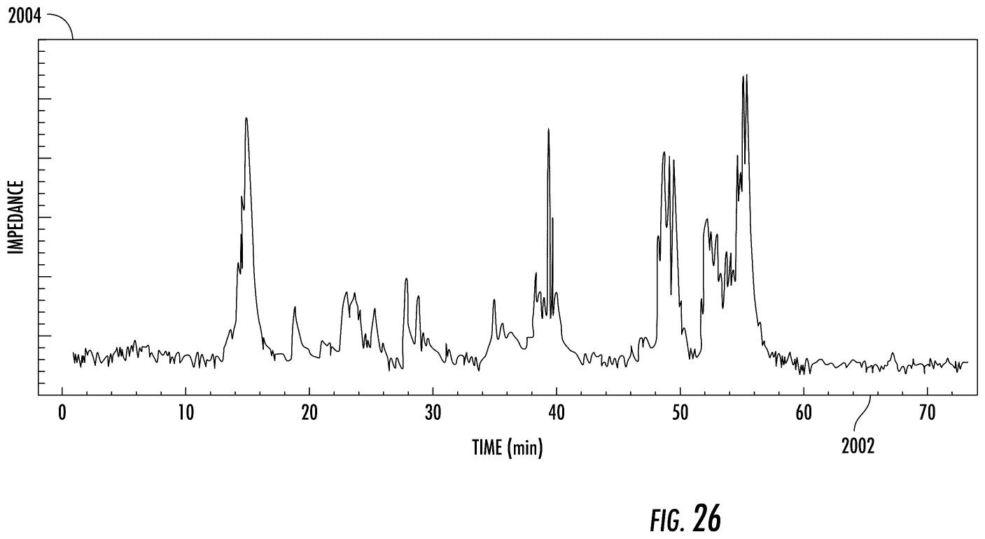

In another experiment, measurements of the response of the multi-gas monitor to methane gas were performed outdoors under dynamic field conditions. FIG. 26 illustrates graphical results of monitoring of dynamic methane plumes outdoors using the developed multi-gas monitor. Time is on the x-axis 2002 and impedance is on the y-axis 2004. Uncontrolled wind conditions can produce a response pattern of the monitor that can be affected by variable wind direction and variable wind speed. As a result, detected gas concentrations can be the result of convolution between variable wind direction and wind speed. Thus, such results can provide the knowledge about maximum concentrations of gas that reach the detector at certain times.

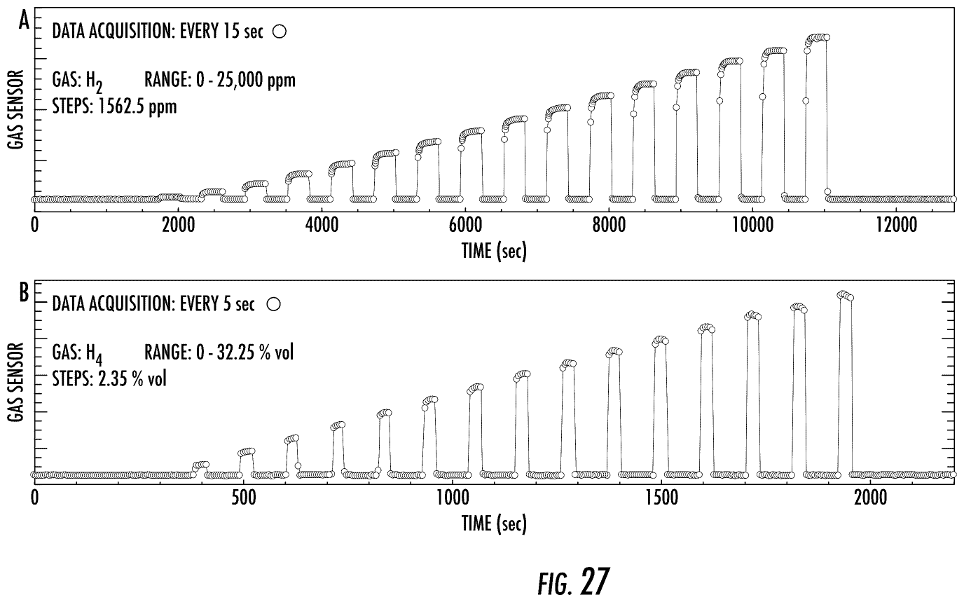

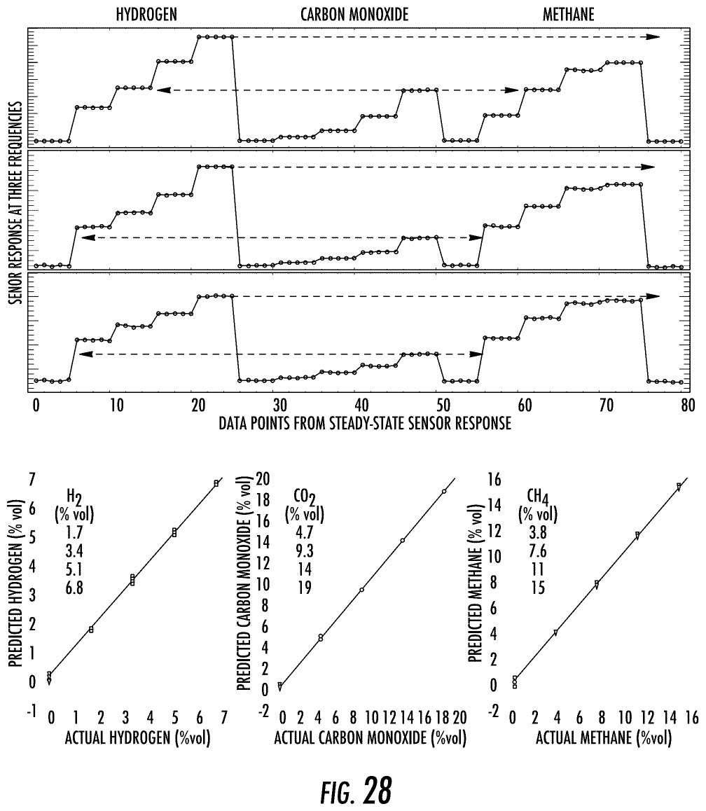

In another experiment, measurements of the response of the multi-gas sensor to monitor the response of H₂ and CH₄ were conducted. FIG. 27 illustrates graphical results of these measurements. In particular, FIG. 27 depicts response speeds of H₂ and CH₄ detection using a multi-gas sensor in accordance with one or more exemplary aspects of the present disclosure. In the top graph, Graph A, H₂ sensor data collection was every 15 seconds, and one or two data points were needed to achieve a 90% of sensor equilibrated response to H₂. In the bottom graph, Graph B, CH₄ sensor data collection was every 5 seconds, and one data point was needed to achieve a 90% of sensor equilibrated response to CH₄.

In the test with H₂, sensor data was collected every 15 seconds (Graph A) and it was observed that the multi-gas sensor needed only one or two data points to achieve 90% of its equilibrated response to the increasing H₂ concentrations. Response to CH₄, however, was even faster. Sensor data for CH₄ was collected every 5 second (Graph B) and it was observed that the multi-gas sensor needed only one data point to achieve 90% of its equilibrated response to the increasing CH₄ concentrations.

Results for detection of three gases H₂, CH₄, and CO relevant to SOFC monitoring at their relevant high concentrations are depicted in FIG. 28. In particular, referring to FIG. 28, excitation parameters were identified from the multi-gas sensors (also known as variable control parameters) to detect and quantify H₂, CO, and CH₄ gases with a single multi-gas sensor. FIG. 28 illustrates results for quantitation of H₂, CO, and CH₄ gases with a single multi-gas sensor. Three steady-state responses of the single multi-gas sensor to three gases recorded at different excitation frequencies (also known as variable control parameters) are depicted in Graphs, A, B, and C, respectively, in FIG. 28. The dotted horizontal lines highlight the different response patterns to three gases at three frequencies. In addition, a machine learning tool was applied, such as support vector machine (SVM), to cross-validate the quantitation of H₂, CO, and CH₄ gases using this multi-gas sensor, depicted in Graphs D, E, and F.

In one or more embodiments of the subject matter described herein, a multi-gas sensing system includes a sensing circuit comprising one or more sensing elements. Each of the one or more sensing elements includes a sensing material configured to detect at least one gas analyte. A management circuit is configured to excite the one or more sensing elements with an alternating current at at least one predetermined frequency. The management circuit measures one or more electrical responses of the one or more sensing elements responsive to exciting the one or more sensing elements with the alternating current at the at least one predetermined frequency. The management circuit determines one or more characteristics of the sensing circuit. One or more processors receive the one or more electrical responses of the one or more sensing elements and the one or more characteristics of the sensing circuit. The one or more processors determine a concentration of the at least one gas analyte based on the one or more electrical responses of the one or more sensing elements and the one or more characteristics of the sensing circuit.

Further aspects are provided by the subject matter of the following clauses:

A fuel cell assembly comprising: a fuel cell stack comprising a fuel cell, the fuel cell comprising a cathode and an anode; and a multi-gas sensor configured to sense gas composition data of a flow of output products from the cathode, gas composition data of a flow of output products from the anode, gas composition data of a fluid surrounding the fuel cell, or a combination thereof to determine fuel cell leakage diagnostic information.

The fuel cell assembly of one or more of these clauses, wherein the multi-gas sensor provides real-time, in situ sensing data with more than one electrical output, and wherein the gas composition data comprises gas composition data of more than one gas.

The fuel cell assembly of one or more of these clauses, wherein the gas sensor is configured to detect a crossover leakage by sensing gas composition data of the flow of output products from the anode.

The fuel cell assembly of one or more of these clauses, wherein the gas composition data comprises a percentage of N₂ in the flow of output products from the anode, and wherein the fuel cell assembly is further configured to sense data indicative of a flowrate of the output products from the anode.

The fuel cell assembly of one or more of these clauses, wherein the fuel cell leakage diagnostic information indicates a cathode to anode crossover leakage determined in response to the percentage of N₂ within the flow of output products from the anode increasing, a flowrate of the flow of output products from the anode increasing, or both.

The fuel cell assembly of one or more of these clauses, wherein the gas sensor is configured to sense gas composition data of the flow of output products from the cathode.

The fuel cell assembly of one or more of these clauses, wherein the gas composition data comprises a percentage of CO₂ in the flow of output products from the cathode and a percentage of H₂O in the output products from the cathode, and wherein the fuel cell assembly is further configured to sense data indicative of a flowrate of the flow of output products from the cathode.

The fuel cell assembly of one or more of these clauses, wherein the fuel cell leakage diagnostic information indicates an anode to cathode crossover leakage determined in response to the percentage of CO₂ within the flow of output products from the cathode increasing, the percentage of H₂O within the flow of output products from the cathode increasing, a flowrate of the flow of output products from the cathode increasing, or a combination thereof.

The fuel cell assembly of one or more of these clauses, wherein the gas sensor is further configured to sense gas composition data of the fluid surrounding the fuel cell.

The fuel cell assembly of one or more of these clauses, wherein the gas composition data comprises a percentage of O₂ in the fluid surrounding the fuel cell.

The fuel cell assembly of one or more of these clauses, wherein the fuel cell leakage diagnostic information indicates an anode overboard leakage determined in response to the percentage of O₂ in the fluid surrounding the fuel cell decreasing and the percentage of O₂ in the fluid surrounding the fuel cell being less than a percentage of O₂ in the flow of output products from the cathode.

The fuel cell assembly of one or more of these clauses, wherein the fuel cell leakage diagnostic information indicates a cathode overboard leakage determined in response to the percentage of O₂ in the fluid surrounding the fuel cell decreasing and the percentage of O₂ in the fluid surrounding the fuel cell being greater than a percentage of O₂ in the flow of output products from the cathode.

The fuel cell assembly of one or more of these clauses, wherein the gas sensor is further configured to sense gas composition data of the flow of output products from the anode.

The fuel cell assembly of one or more of these clauses, wherein the gas sensor is a single gas sensor.

The fuel cell assembly of one or more of these clauses, wherein the gas sensor comprises a first gas sensor configured to sense gas composition data of the flow of output products from the cathode and a second gas sensor configured to sense gas composition data of the flow of output products from the anode.

The fuel cell assembly of one or more of these clauses, wherein the fuel cell assembly further comprises an enclosure at least partially enclosing the fuel cell stack, and wherein the gas sensor positioned outside the enclosure.

The fuel cell assembly of one or more of these clauses, the fuel cell assembly is part of a propulsion system for an aircraft, wherein the propulsion system further comprises a gas turbine engine comprising a combustion section having a combustor, and wherein the fuel cell is configured to provide the flow of output products from the anode and from the cathode to the combustor.

A method of detecting a leak in a fuel cell of a fuel cell assembly of a propulsion system, the fuel cell comprising a cathode and an anode, the method comprising: receiving from a gas sensor gas composition data of a flow of output products from the cathode, gas composition data of a flow of output products from the anode, gas composition data of a fluid surrounding the fuel cell, or a combination thereof; and determining fuel cell leakage diagnostic information in response to the received gas composition data.

The method of one or more of these clauses, wherein receiving the gas composition data comprises receiving data at a resolution of 1 minute or less.

A propulsion system comprising: a propulsor; and a fuel cell assembly operable with the propulsor, the fuel cell assembly comprising a fuel cell stack comprising a fuel cell, the fuel cell comprising a cathode and an anode; and a gas sensor configured to sense gas composition data of a flow of output products from the cathode, gas composition data of a flow of output products from the anode, gas composition data of a fluid surrounding the fuel cell, or a combination thereof to determine fuel cell leakage diagnostic information.

The fuel cell assembly of one or more of these clauses, wherein gas sensor is a vibrational and rotational spectroscopy monitor.

The fuel cell assembly of one or more of these clauses, wherein gas sensor is a Raman spectroscopy monitor.

The method of one or more of these clauses, wherein receiving the gas composition data comprises receiving data indicative of a percentage of N₂ in the flow of output products from the anode increasing, and wherein determining the fuel cell leakage diagnostic information comprises determining a crossover gas leak in the fuel cell from the cathode to the anode.

The method of one or more of these clauses, wherein receiving the gas composition data comprises receiving data indicative of a percentage of CO₂, H₂O, or both in the flow of output products from the cathode increasing, and wherein determining the fuel cell leakage diagnostic information comprises determining a crossover gas leak in the fuel cell from the anode to the cathode.

The method of one or more of these clauses, wherein receiving the gas composition data comprises receiving data indicative of a percentage of O₂ in the fluid surrounding the fuel cell decreasing, and wherein determining the fuel cell leakage diagnostic information comprises determining an overboard gas leak in the fuel cell from the anode.

The method of one or more of these clauses, wherein receiving the gas composition data comprises receiving data indicative of a percentage of O₂ in the fluid surrounding the fuel cell increasing, and wherein determining the fuel cell leakage diagnostic information comprises determining an overboard gas leak in the fuel cell from the cathode.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A fuel cell assembly comprising:
a fuel cell stack comprising a fuel cell, the fuel cell comprising a cathode and an anode; and
a multi-gas sensor configured to sense gas composition data of a flow of output products from the cathode, gas composition data of a flow of output products from the anode, gas composition data of a fluid surrounding the fuel cell, or a combination thereof to determine fuel cell leakage diagnostic information.

2. The fuel cell assembly of claim 1, wherein the multi-gas sensor provides real-time, in situ sensing data with more than one electrical output, and wherein the gas composition data comprises gas composition data of more than one gas.

3. The fuel cell assembly of claim 1, wherein the gas sensor is configured to detect a crossover leakage by sensing gas composition data of the flow of output products from the anode.

4. The fuel cell assembly of claim 3, wherein the gas composition data comprises a percentage of N₂ in the flow of output products from the anode, and wherein the fuel cell assembly is further configured to sense data indicative of a flowrate of the output products from the anode.

5. The fuel cell assembly of claim 4, wherein the fuel cell leakage diagnostic information indicates a cathode to anode crossover leakage determined in response to the percentage of N₂ within the flow of output products from the anode increasing, a flowrate of the flow of output products from the anode increasing, or both.

6. The fuel cell assembly of claim 1, wherein the gas sensor is configured to sense gas composition data of the flow of output products from the cathode.

7. The fuel cell assembly of claim 6, wherein the gas composition data comprises a percentage of CO₂ in the flow of output products from the cathode and a percentage of H₂O in the output products from the cathode, and wherein the fuel cell assembly is further configured to sense data indicative of a flowrate of the flow of output products from the cathode.

8. The fuel cell assembly of claim 7, wherein the fuel cell leakage diagnostic information indicates an anode to cathode crossover leakage determined in response to the percentage of CO₂ within the flow of output products from the cathode increasing, the percentage of H₂O within the flow of output products from the cathode increasing, a flowrate of the flow of output products from the cathode increasing, or a combination thereof.

9. The fuel cell assembly of claim 8, wherein the gas sensor is further configured to sense gas composition data of the fluid surrounding the fuel cell.

10. The fuel cell assembly of claim 9, wherein the gas composition data comprises a percentage of O₂ in the fluid surrounding the fuel cell.

11. The fuel cell assembly of claim 10, wherein the fuel cell leakage diagnostic information indicates an anode overboard leakage determined in response to the percentage of O₂ in the fluid surrounding the fuel cell decreasing and the percentage of O₂ in the fluid surrounding the fuel cell being less than a percentage of O₂ in the flow of output products from the cathode.

12. The fuel cell assembly of claim 10, wherein the fuel cell leakage diagnostic information indicates a cathode overboard leakage determined in response to the percentage of O₂ in the fluid surrounding the fuel cell decreasing and the percentage of O₂ in the fluid surrounding the fuel cell being greater than a percentage of O₂ in the flow of output products from the cathode.

13. The fuel cell assembly of claim 8, wherein the gas sensor is further configured to sense gas composition data of the flow of output products from the anode.

14. The fuel cell assembly of claim 13, wherein the gas sensor is a single gas sensor.

15. The fuel cell assembly of claim 13, wherein the gas sensor comprises a first gas sensor configured to sense gas composition data of the flow of output products from the cathode and a second gas sensor configured to sense gas composition data of the flow of output products from the anode.

16. The fuel cell assembly of claim 1, wherein the fuel cell assembly further comprises an enclosure at least partially enclosing the fuel cell stack, and wherein the gas sensor is positioned outside the enclosure.

17. The fuel cell assembly of claim 1, wherein the fuel cell assembly is part of a propulsion system for an aircraft, wherein the propulsion system further comprises a gas turbine engine comprising a combustion section having a combustor, and wherein the fuel cell is configured to provide the flow of output products from the anode and from the cathode to the combustor.

18. A method of detecting a leak in a fuel cell of a fuel cell assembly of a propulsion system, the fuel cell comprising a cathode and an anode, the method comprising:
receiving from a gas sensor gas composition data of a flow of output products from the cathode, gas composition data of a flow of output products from the anode, gas composition data of a fluid surrounding the fuel cell, or a combination thereof; and
determining fuel cell leakage diagnostic information in response to the received gas composition data.

19. The method of claim 18, wherein receiving the gas composition data comprises receiving data at a resolution of 1 minute or less.

20. A propulsion system comprising:
a propulsor; and
a fuel cell assembly operable with the propulsor, the fuel cell assembly comprising:
a fuel cell stack comprising a fuel cell, the fuel cell comprising a cathode and an anode; and
a gas sensor configured to sense gas composition data of a flow of output products from the cathode, gas composition data of a flow of output products from the anode, gas composition data of a fluid surrounding the fuel cell, or a combination thereof to determine fuel cell leakage diagnostic information.
